(19) United States
(12) Patent Application Publication
(10) Pub. No.: US 2008/0158274 A1
(43) Pub. Date: Jul. 3, 2008

(54) Printer and printing method

(75) Inventor: Kazutaka Tasaka, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/005,299

(22) Filed: Dec. 27, 2007

(30) Foreign Application Priority Data
Dec. 27, 2006 (JP) P2006-352340

(51) Int. Cl. B41J 29/38

(52) U.S. Cl. 347/8; 347/102

(57) ABSTRACT

A head of a printer has a nozzle unit for ejecting fine droplets of light curable ink and a light irradiation part for irradiating light to ink ejected onto a base member. In printing an image, distortion information representing a relationship between a density distribution of an image printed on the base member and distortion of the base member by temperature rise caused by irradiation with light from the light irradiation part is prepared and writing data is generated by modifying a target image on the basis of a density distribution of the target image and the distortion information. Ejection of ink from the head is controlled in synchronization with relative movement of the head in accordance with the writing data, and it is possible to accurately print the target image on the base member in consideration of distortion of the base member caused by irradiation with the light.

### BACKGROUND OF THE INVENTION

1. Field of the Invention

The present invention relates to a technique for printing on a printing medium in an inkjet manner.

2. Description of the Background Art

An inkjet printer for printing on a printing paper conventionally has been used where a head having an array of a plurality of outlets for ejecting fine droplets of ink is moved along the printing paper. In recent, there is a demand to perform printing on various printing mediums, and in a case where printing is performed on a printing medium with hydrophobicity such as plastic (for example, polycarbonate or PET (polyethylene terephthalate)), UV (ultraviolet) curable ink is used and ink which has just been ejected onto the printing medium is hardened by UV light applied from a light irradiation part.

Japanese Patent Application Laid-Open No. 2004-306299 discloses a technique for easily dealing with a phenomenon, so-called fan-out, where a printing paper expands in printing by a printer with a printing plate. In the technique, a modified image is obtained by modifying a width in a sub scan direction of an image to be printed by computation, and a writing clock is shifted in recording the image by irradiating a light beam to a printing plate to modify a length in a main scan direction of the image written on the printing plate.

In a printer using the UV curable ink, since UV light from a light irradiation part are applied to a printing medium in printing, a temperature of the printing medium increases and an image is printed in a state where the printing medium is expanded (the state including the process of expansion). Therefore, the image printed on the printing medium is distorted in a state where the printing medium is back to room temperature after printing is performed. Actually, since temperature change in each position on the printing medium depends on a density of the image printed on the printing medium or the like, distortion of the printing medium in printing is not constant and it is extremely difficult to accurately print an image on the printing medium.

### SUMMARY OF THE INVENTION

The present invention is intended for an inkjet printer. It is an object of the present invention to accurately print an image on a printing medium in printing using light curable ink.

The printer according to the present invention comprises: a holding part for holding a printing medium; a head having a plurality of outlets arranged in a predetermined arrangement direction which is parallel to the printing medium, the plurality of outlets ejecting fine droplets of light curable ink onto the printing medium; a light irradiation part for irradiating light to ink which is ejected onto the printing medium; a scanning mechanism for moving the head and the light irradiation part relatively to the holding part in a main scan direction perpendicular to the arrangement direction and intermittently moving the head and the light irradiation part relatively to the holding part in a sub scan direction along the arrangement direction every time when movement in the main scan direction is performed; a storage part for storing distortion information representing a relationship between an average density or a density distribution of an image printed on a printing medium and distortion of the printing medium by temperature rise caused by irradiation with the light; an operation part for generating writing data by modifying a target image to be printed on the basis of the distortion information and an average density or a density distribution of the target image; and a control part which controls relative movement of the head by the scanning mechanism and ejection of ink from the head in synchronization with each other, in accordance with the writing data.

According to the present invention, it is possible to accurately print the target image on the printing medium in consideration of distortion of the printing medium caused by irradiation with the light from the light irradiation part, in printing using the light curable ink.

According to a preferred embodiment of the present invention, the operation part obtains respective densities of a plurality of divided areas acquired by dividing the target image to acquire the density distribution of the target image and generates the writing data on the basis of the density distribution. It is thereby possible to obtain the writing data with accuracy.

According to another preferred embodiment of the present invention, the target image is a set of a plurality of color component images which respectively correspond to a plurality of colors, the head ejects fine droplets of inks of the plurality of colors onto the printing medium, the distortion information represents, with respect to each of the plurality of colors, a relationship between an average density or a density distribution of an image printed on a printing medium and distortion of the printing medium by temperature rise caused by irradiation with the light, and the operation part acquires the writing data by modifying the plurality of color component images in the same manner on the basis of the distortion information and a plurality of average densities or a plurality of density distributions of the plurality of color component images. As a result, it is possible to print the color target image on the printing medium with accuracy.

According to an aspect of the present invention, the holding part is a stage which is in contact with a surface of the printing medium, and the printing medium held on the stage has translucency to the light. More preferably, the printer further comprises a temperature control part for controlling a temperature of the stage to make the temperature at the start time of the first printing constant. It is thereby possible to print the target image with high reproduction.

According to another aspect of the present invention, the writing data includes: image data acquired by distorting the target image in a direction corresponding to the sub scan direction; and modification data for shifting ejection timing of ink in main scanning of the head. This makes it possible to print the target image on the printing medium at high speed.

The present invention is also intended for a printing method of printing in an inkjet printer.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an appearance of a printer;

FIG. 2 is a view showing a stage and a head overlapping each other;

FIG. 3 is a bottom plan view showing the head;

FIG. 4 is a block diagram showing functional constitutions of a control unit;

FIG. 5 is a flowchart showing an operation flow for printing an image on a base member in the printer;

FIG. 6 is a view showing a writing position arrangement;

FIG. 7 is a view for explaining an amount of movement in a row direction of the head;

FIG. 8 is a graph showing an example of temperature change of the stage;

FIG. 9A is a flowchart showing a flow of process for generating distortion information;

FIG. 9B is a conceptual view showing summary of a distortion information generation process;

FIGS. 10A to 10 E are views each showing a density grid image;

FIGS. 11A to 11E are views each showing a density grid image printed on a reference base member;

FIG. 12 is a view showing a grid line group of a density grid image of 0%;

FIG. 13 is a view showing a basic displacement table;

FIG. 14 is a graph showing a relationship between a density and a distortion amount relative to a standard intersection point in a density grid image;

FIG. 15 is a flowchart showing a flow of process for generating writing data;

FIG. 16 is a view for explaining arrangement of an original image;

FIG. 17 is a view showing a standard divided area;

FIG. 18 is a view for explaining modification of a target image;

FIG. 19 is a graph showing temperature change of the stage;

FIGS. 20A and 20B are views each showing a part of a writing position arrangement; and

FIG. 21 is a view for explaining modification of a target image.

### DESCRIPTION OF THE PREFERRED EMBODIMENTS

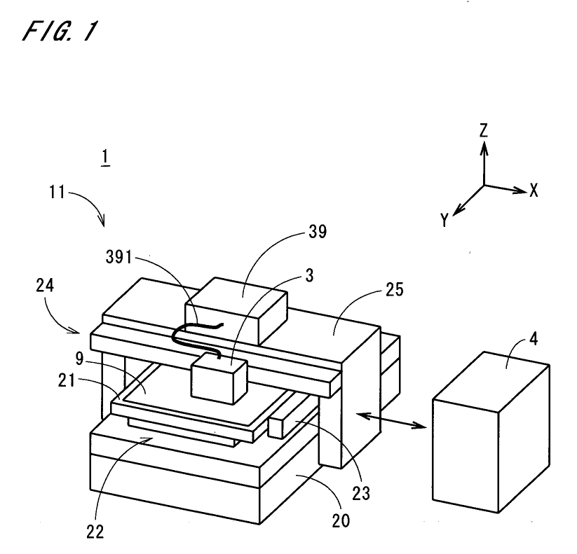

FIG. 1 is a perspective view showing an appearance of a printer 1 in accordance with the first preferred embodiment of the present invention. The printer 1 performs color printing in an inkjet manner on a plate-like or sheet-like base member 9 which is formed of plastic with hydrophobicity (liquid repellency) such as polycarbonate or PET (polyethylene terephthalate). The base member 9 on which an image is printed by the printer 1 is used as a display panel or the like in various apparatuses.

The printer 1 of FIG. 1 has a main body 11 and a control unit 4, and the main body 11 has a stage 21 for holding the transparent and rectangular base member 9 on a surface on the (+Z) side of FIG. 1 (the surface is hereinafter, referred to as “upper surface”), a stage moving mechanism 22 provided on a base part 20, and a head 3 for ejecting fine droplets of ink onto the base member 9 held on the stage 21.

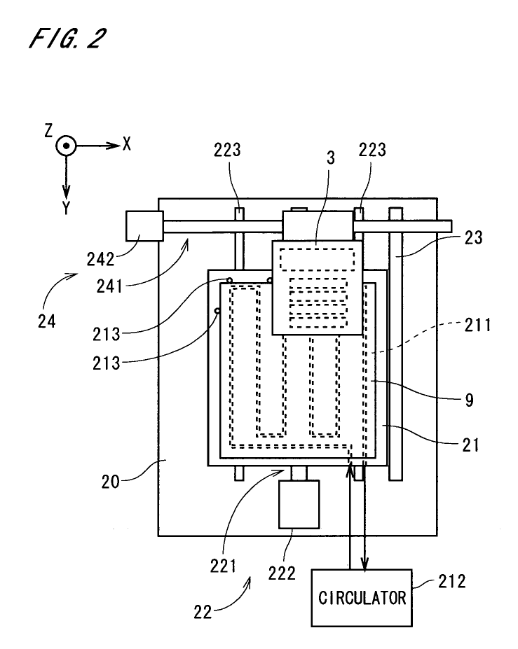

FIG. 2 is a plan view showing the stage 21 and the head 3 overlapping each other, and a later-discussed flame 25 is not shown in FIG. 2. A nut of a ball screw mechanism 221 of the stage moving mechanism 22 is fixed on a surface of the stage 21 which is opposite to the upper surface on which the base member 9 is held. By rotating a motor 222 connected to the ball screw mechanism 221, the stage 21 smoothly moves in the Y direction (main scan direction) of FIG. 2 along rails 223. A position detection module 23 is further provided on the base part 20 to detect a position of the stage 21 relative to the base part 20.

The stage 21 is formed of material with a low coefficient of thermal expansion and the upper surface is colored with silver. As shown by broken lines in FIG. 2, a water passage 211 is formed in the stage 21. The passage 211 is repeatedly bent in the order of the X direction and the Y direction so as to pass almost whole of the stage 21 along the XY plane in FIG. 2. Both ends of the passage 211 are connected to a circulator 212, and water circulates in the circulator 212 and the passage 211 while a temperature of the water is controlled by the circulator 212, and the stage 21 is thereby kept at a predetermined temperature when printing is not performed.

The head 3 is positioned above the stage 21, and the head 3 is held by a head moving mechanism 24, which has a ball screw mechanism 241 and a motor 242, so as to be movable in a sub scan direction (the X direction of FIG. 2) which is perpendicular to the main scan direction and is along a main surface of the base member 9. As shown in FIG. 1, the head moving mechanism 24 is fixed on the flame 25 which is attached to the base part 20 over the stage 21. A light source 39 for emitting UV (ultraviolet) light is provided on the flame 25, and light emitted from the light source 39 is directed into the head 3 through a plurality of optical fibers (actually, a bundle of the plurality of optical fibers which are shown by a thick line 391 in FIG. 1).

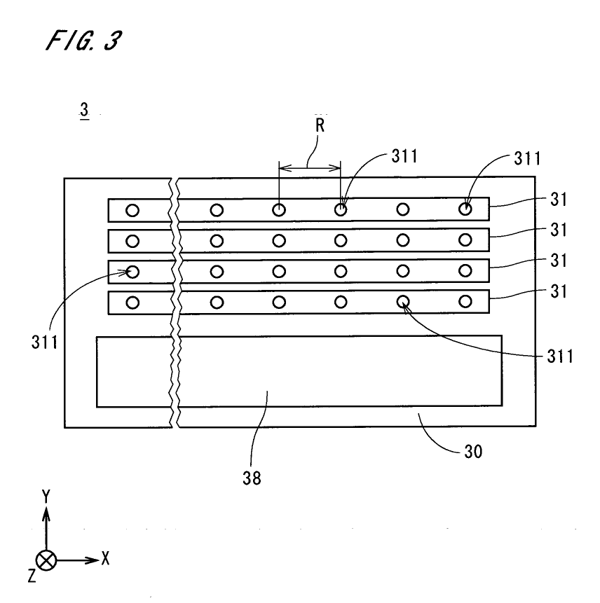

FIG. 3 is a bottom plan view showing the head 3. As shown in FIG. 3, the head 3 has a plurality of (four in FIG. 3) nozzle units 31 for ejecting inks of different colors, and the plurality of nozzle units 31 are arranged in the Y direction and fixed on a main body 30 of the head 3. A nozzle unit 31 at the end on the (+Y) side of FIG. 3 ejects ink of K (black), a nozzle unit 31 on the (−Y) side of the nozzle unit 31 of K ejects ink of C (cyan), a nozzle unit 31 on the (−Y) side of the nozzle unit 31 of C ejects ink of M (magenta), and a nozzle unit 31 at the end on the (−Y) side ejects ink of Y (yellow). In each nozzle unit 31, a plurality of (for example, 300) outlets 311 are arranged in an arrangement direction (the X direction of FIG. 3), which is parallel to the base member 9 on the stage 21 and is perpendicular to the main scan direction, at a regular pitch R (for example, the pitch R is a pitch of 169 micrometers (μm) corresponding to 150 dpi (dot per inch), and hereinafter referred to as “outlet pitch R”). Outlets 311 corresponding one another in the plurality of nozzle units 31 are arranged at the same position in the X direction. Ink of each color includes UV curing agent and has UV curability. The nozzle units 31 of CMYK may be sequentially shifted in the X direction in accordance with a resolution of printing which is later discussed, and nozzle units for other colors such as light cyan, light magenta and white may be further provided in the head 3.

In the head 3, a light irradiation part 38 connected to the light source 39 is provided on the (−Y) side of the plurality of nozzle units 31. The plurality of optical fibers are arranged along the X direction in the light irradiation part 38, and the light irradiation part 38 applies (irradiates) UV light to a linear region which extends in the X direction on the base member 9.

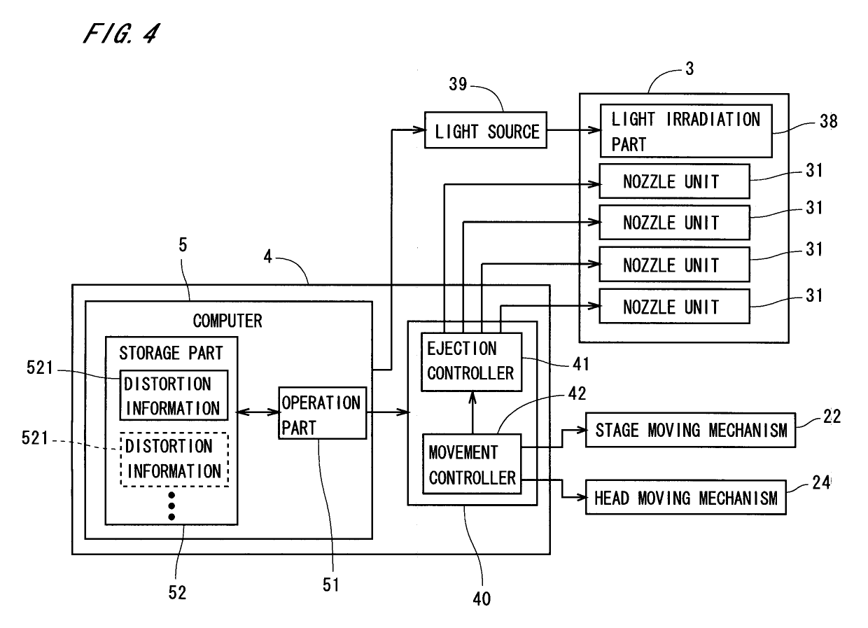

FIG. 4 is a block diagram showing functional constitutions of the control unit 4. As shown in FIG. 4, the control unit 4 has a main body control part 40 and a computer 5, and the main body control part 40 has an ejection controller 41 for performing control associated with ejection of inks from the plurality of nozzle units 31 of the head 3 and a movement controller 42 for performing movement control of the stage moving mechanism 22 and the head moving mechanism 24. The computer 5 is constituted of a CPU for performing various computations, a memory for storing various pieces of information, and the like. In FIG. 4, also shown are functional constitutions (an operation part 51 and a storage part 52 in FIG. 4) implemented by executing a predetermined program in the computer 5. In the printer 1, writing data used in printing is generated from an image to be printed on the base member 9 by the operation part 51 and the ejection controller 41 controls ejection of inks from the head 3 in synchronization with the movement control by the movement controller 42, in accordance with the writing data, to thereby print an image on the base member 9.

Next discussion will be made on an operation for printing an image on the base member 9 in the printer 1, referring to FIG. 5. Herein, a basic operation for printing in the printer 1 is first described with reference to processes of Steps S13 to S20 in FIG. 5 and an operation for actual printing in the printer 1 is described later. Though the following discussion will be made on only the nozzle unit 31 for one ink of CMYK, the same operation is performed for the other colors.

In the printer 1, first, the base member 9 to be printed is loaded in the printer 1 and placed on the stage 21 of FIG. 2. With this operation, the base member 9 is held in a state where a surface of the base member 9 which is opposite to the other surface facing the head 3 is in contact with the upper surface of the stage 21 (Step S13). At this time, by bringing edges of the base member 9 into contact with a plurality of positioning pins 213 on the stage 21, the base member 9 is accurately positioned relatively to the stage 21 in a state where each edge of the base member 9 is parallel to the X direction or the Y direction. Subsequently, the movement controller 42 controls the stage moving mechanism 22 and the head moving mechanism 24, and the head 3 is thereby arranged at a predetermined initial position on the (−Y) side and the (−X) side of the base member 9 (an initial position of both of the main scan direction and the sub scan direction) (that is to say, the head 3 returns its home position). The stage 21 starts to move in the (−Y) direction and the head 3 performs main scanning relatively to the base member 9 in the (+Y) direction at a constant speed (Step S14).

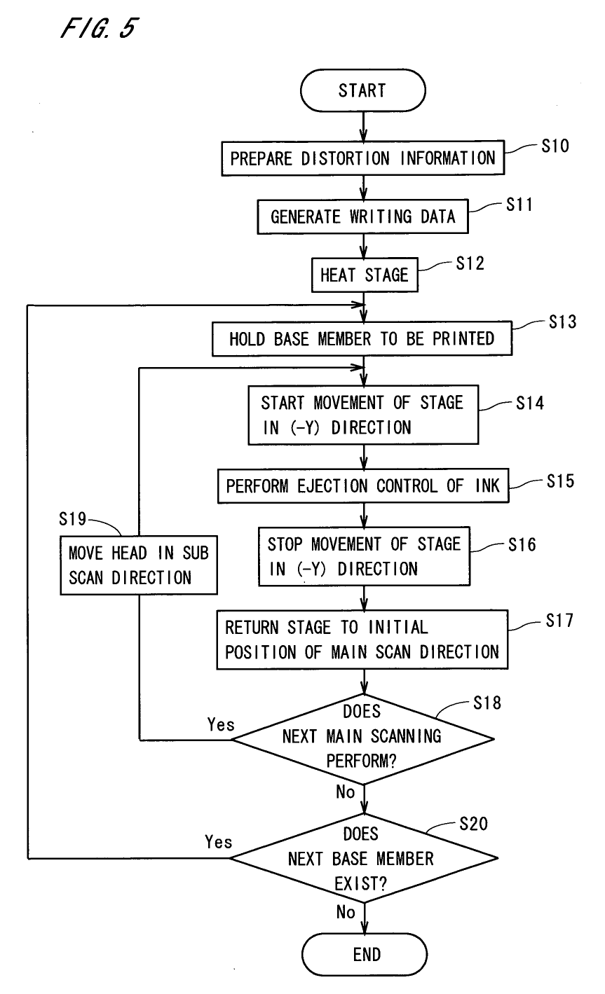

FIG. 6 is a view showing a writing position arrangement 80 defined on the main surface of the base member 9. In FIG. 6, nozzle units of one color in a plurality of main scannings of the head 3 are also shown by double-dashed lines (the nozzle units are assigned reference sings 31A to 31D, respectively). Though the base member 9 is actually thermally expanded in the process of printing due to the UV light emitted from the light irradiation part 38 in printing, the thermal expansion of the base member 9 is omitted in the following description of the basic operation.

The writing position arrangement 80 is a set of a plurality of writing positions which are arranged in a row direction (the X direction of FIG. 6) parallel to the sub scan direction and a column direction (the Y direction of FIG. 6) parallel to the main scan direction on the main surface of the base member 9, and each writing position is shown by a rectangle 81 in FIG. 6. In the present preferred embodiment, both of pitches in the row direction and the column direction of the writing positions 81 (each pitch is hereinafter also referred to as “writing pitch”) are made to ¼ the outlet pitch R, and in a case where the outlet pitch R corresponds to 150 dpi as described above, the writing pitch is 42 μm (micrometer) corresponding to 600 dpi. The pitches in the row and column directions of the writing positions 81 may be made to ⅙, ⅛ or the like of the outlet pitch R, and the pitches in the row direction and the column direction may be different from each other.

In the printer 1, the head 3 moves relatively to the base member 9 in the main scan direction (performs main scanning), each of the plurality of outlets 311 of the head 3 passes writing positions 81 arranged in the column direction (hereinafter, also referred to as “writing position column”) and ejection control of ink in each outlet 311 is performed on each of the writing positions 81 included in the writing position column corresponding to the outlet 311 on the basis of control of the ejection controller 41 (Step S15). Since the pitches in the column direction of the writing positions 81 are constant and a moving speed of the stage 21 is also made constant, the ejection control of ink in each outlet 311 is performed at a regular basic cycle. At this time, (fine droplets of) ink which has just been ejected onto the base member 9 hardens due to the UV light applied to the base member 9 from the light irradiation part 38 of the head 3. In FIG. 6, a nozzle unit used in the first main scanning is shown by the reference sign 31A, and each of dots formed on the base member 9 by each outlet 311 in the first main scanning is shown by a circled number “1”. In FIG. 6, dots are virtually formed also in a case where ejection of ink is not performed in accordance with writing data.

Actually, each outlet 311 can continuously eject a plurality of fine droplets of ink for a small time period, each of the fine droplets being almost same amount, and the writing data includes instructions of the number of fine droplets which should be ejected to each writing position 81. In the present preferred embodiment, an operation where fine droplet(s) of any number from 0 to 3 is continuously ejected for the small time period is regarded as one ejection control of ink. In the nozzle unit 31, a fall speed of a fine droplet which is first ejected out of the plurality of fine droplets of ink ejected continuously, is slower than those of the following fine droplets due to the influence of air resistance. Therefore, it is possible to make these fine droplets of ink collide one another during falling and land them as one droplet of ink on the base member 9.

In the printer 1, the ejection control of ink is performed to each of writing positions 81 on the base member 9 which are passed by each outlet 311, and when the head 3 reaches an end portion on the (+Y) side of the base member 9, movement of the stage 21 (main scanning of the head 3) is stopped (Step S16). After the stage 21 is returned to the initial position of the main scan direction (Step S17) and it is confirmed the next main scanning of the head 3 is performed (Step S18), the head 3 moves in the X direction along the arrangement direction of the outlets 311 (performs sub scanning) and each outlet 311 of the nozzle unit 31 is positioned at a position in the row direction which is away on the (+X) side of the writing position column, where any outlet 311 has passed in the first main scanning, by the writing pitch (see a nozzle unit 31B in FIG. 6) (Step S19). As discussed later, since an amount of movement in the row direction of the head 3 in Step S19 is made greater than the outlet pitch R, not all outlets 311 of the nozzle unit 31 are actually positioned at positions adjacent on the (+X) side of the writing position columns where ejection controls are performed in the first main scanning (the same is applied to the following discussion).

When the sub scanning of the head 3 is finished, the stage 21 starts to move in the (−Y) direction (Step S14) and the ejection control of ink is performed on each of writing positions 81 included in the writing position column passed by each outlet 311 (Step S15). In FIG. 6, each of dots which are formed on the base member 9 by each outlet 311 in the second main scanning of the head 3 is shown by a circled number “2”.

When the second main scanning of the head 3 is finished (Step S16), the stage 21 is returned to the initial position of the main scan direction (Step S17). After it is confirmed the next main scanning of the head 3 is performed (Step S18), the head 3 performs sub scanning and each outlet 311 of the nozzle unit 31 is positioned at a position in the row direction which is away on the (+X) side of the writing position column, where any outlet 311 has passed in the second main scanning, by the writing pitch (see a nozzle unit 31C in FIG. 6) (Step S19). Then, the stage 21 starts to move in the (−Y) direction (Step S14) and the ejection control of ink is performed to each of writing positions 81 included in the writing position column passed by each outlet 311 (Step S15). In FIG. 6, each of dots which are formed on the base member 9 by each outlet 311 in the third main scanning of the head 3 is shown by a circled number “3”.

When the third main scanning of the head 3 is finished (Step S16), the stage 21 is returned to the initial position of the main scan direction (Step S17), the head 3 performs sub scanning and each outlet 311 is positioned at a position in the row direction which is away on the (+X) side of the writing position column, where any outlet 311 has passed in the third main scanning, by the writing pitch (see a nozzle unit 31D in FIG. 6) (Steps S18, S19). Then, the ejection control of ink is performed to each of writing positions 81 included in the writing position column passed by each outlet 311, in synchronization with main scanning of the head 3 (Steps S14, S15). In FIG. 6, each of dots which are formed on the base member 9 by each outlet 311 in the fourth main scanning of the head 3 is shown by a circled number “4”. When the main scanning of the head 3 is finished (Step S16), the stage 21 is returned to the initial position of the main scan direction (Step S17).

Herein, looking at a set of four writing positions 81 which are continuous in a line in the row direction in the writing position arrangement 80 of FIG. 6 (the set is a set of writing positions 81 surrounded by a thick-line rectangle 82 in FIG. 6 and hereinafter, referred to as “writing block 82”), every time when (any outlet 311 of) the head 3 passes each writing block 82, the ejection control of ink from the outlet 311 is performed one time to any writing position 81 in the writing block 82. The head 3 passes the writing block 82 by the number of times corresponding to the number of the writing positions 81 included in the writing block 82 and thereby one ejection control of ink to each of the writing positions 81 included in the writing block 82 is finished (i.e., an interlaced process is performed in the sub scan direction). Therefore, the writing position arrangement 80 can be thought to be divided into a plurality of writing blocks 82 each of which is a set of the writing positions 81 continuous in the row direction, in each writing block 82 the ejection control of ink to each of the writing positions is performed one time in one main scanning different from one another. A width in the X direction of the writing block 82 is equal to the outlet pitch R.

As discussed later, the above Step S19 and Steps S14 to S17 are repeated until one ejection control is performed to each of all the writing positions 81 in the writing position arrangement 80 (Step S18), to print the whole image to be written on the base member 9.

Since outlets 311 corresponding one another in the plurality of nozzle units 31 are arranged at the same position in the X direction in the printer 1 (see FIG. 3), inks of CMYK are ejected to the same writing position 81 in the writing block 82 with a main scanning of the head 3 and the inks are hardened by the light irradiation part 38 at the same time. Also in this case, since the inks of CMYK do not completely mix before being hardened, there arises no problem in a printed color image.

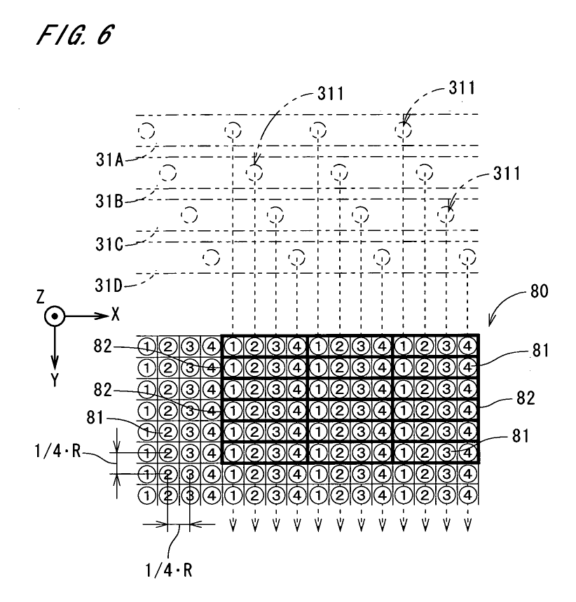

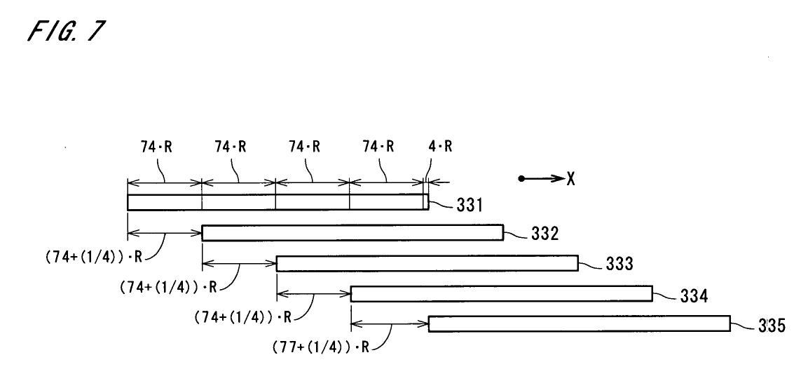

Discussion will be made on an amount of movement in the row direction of the head 3 in Step S19. FIG. 7 is a view for explaining the amount of movement in the row direction of the head 3. In FIG. 7, the plurality of outlets 311 arranged in the nozzle unit 31 are shown by one rectangle, and the plurality of outlets 311 in the first to fifth main scannings of the head 3 are represented by rectangles 331 to 335, respectively.

As described earlier, the 300 outlets 311 are formed in each nozzle unit 31 in the printer 1, and in the first main scanning of the head 3, the ejection control of ink is performed to each writing block 82 in a range corresponding to 300 writing blocks 82 arranged in the row direction on the base member 9. In each writing block 82 passed by the head 3 in a main scanning, if a writing position 81 where the ejection control of ink is performed is referred to as a “target writing position 81”, a writing position 81 at the end on the (−X) side is the target writing position 81 in the first main scanning of the head 3.

In sub scanning after the first main scanning of the head 3, the head 3 moves in the (+X) direction by a distance (74+(¼)) times the outlet pitch R (a distance in the X direction between the rectangle 331 and the rectangle 332 in FIG. 7). In this time, since a position of an outlet 311 in a nozzle unit 31 moves in the row direction by a distance obtained by adding ¼ times the outlet pitch R to an integral multiple of the outlet pitch R, looking at the X direction, any outlet 311 in the nozzle unit 31 is positioned at a position which is away on the (+X) side from the writing position 81 in each writing block 82, where another outlet 311 of the nozzle unit 31 has passed in the first main scanning, by the writing pitch (writing blocks 82 where 74 outlets 311 on the (−X) side have passed in the first main scanning are excluded). Therefore, in the second main scanning, the target writing position 81 is switched from a writing position 81 of the circled number “1” in FIG. 6 to a writing position 81 of the circled number “2” in each of writing blocks 82 passed by the nozzle unit 31 (accurately, each of writing blocks 82 passed by the nozzle unit 31 in both the first and second main scannings (the same is applied to the following discussion)). Since the amount of movement in the row direction in sub scanning of the head 3 is longer than 4 times the writing pitch (the outlet pitch R) which is the width in the row direction of the writing block 82, an outlet 311 which is different from another outlet 311 which has passed each writing block 82 in the first main scanning, passes the writing block 82 in the second main scanning.

Similarly, after the second main scanning, the head 3 moves in the (+X) direction by a distance (74+(¼)) times the outlet pitch R (i.e., a distance in the X direction between the rectangle 332 and the rectangle 333 in FIG. 7) and in the third main scanning, the target writing position 81 is switched from the writing position 81 of the circled number “2” in FIG. 6 to a writing position 81 of circled number “3” in each of writing blocks 82 passed by the nozzle unit 31. After the third main scanning, the head 3 moves in the (+X) direction by a distance (74+(¼)) times the outlet pitch R (i.e., a distance in the X direction between the rectangle 333 and the rectangle 334 in FIG. 7) and in the fourth main scanning, the target writing position 81 is switched from the writing position 81 of the circled number “3” in FIG. 6 to a writing position 81 of circled number “4” in each of writing blocks 82 passed by the nozzle unit 31.

Since the total amount of movement in the X direction after the first to third main scannings is (222+¾) times the outlet pitch R, an outlet 311 at the end on the (−X) side out of a plurality of outlets 311 (the rectangle 334) in the nozzle unit 31 in the fourth main scanning performs ejection control of ink to each of writing blocks 82 passed by an outlet 311 which is the 78th outlet from the (+X) side toward the (−X) side in the first main scanning. Thus, the ejection control of ink is performed one time to each of all the writing positions 81 in the writing blocks 82 passed by 78 outlets 311 on the (+X) side in the nozzle unit 31 in the first main scanning.

As discussed later, since the head 3 intermittently moves in the (+X) direction also in the fourth and subsequent main scannings, there are writing positions (or a writing position) 81 to which the ejection control of ink is not performed in each of writing blocks 82 passed by 222 outlets 311 on the (−X) side in the nozzle unit 31 in the first main scanning. Therefore, ejection of ink is not performed to all the writing positions 81 included in each of the writing blocks 82 passed by the 222 outlets 311 on the (−X) side in the nozzle unit 31 in the first main scanning (i.e., these writing positions 81 are made to blanks).

Subsequently, after the fourth main scanning, the head 3 moves in the (+X) direction by a distance (77+(¼)) times the outlet pitch R (i.e., a distance in the X direction between the rectangle 334 and the rectangle 335 in FIG. 7) and in the fifth main scanning, the writing position 81 of the circled number “1” in FIG. 6 can be the target writing positions 81 in each of writing blocks 82 passed by the nozzle unit 31. In this time, in each of writing blocks 82 passed by 74 outlets 311 on the (−X) side out of a plurality of outlets 311 shown by the rectangle 335, the ejection control of ink has already finished in writing positions 81 of the circled numbers “2” to “4” in FIG. 6 by the second to fourth main scannings, and therefore, one ejection control of ink to each of all the writing positions 81 in the writing blocks 82 is finished by the fifth main scanning.

The position of the head 3 in the fifth main scanning (the rectangle 335) is away in the X direction from that in the first main scanning (the rectangle 331) by a distance 300 times the outlet pitch R. An outlet 311 at the end on the (−X) side of the nozzle unit 31 in the fifth main scanning passes writing blocks 82 which are adjacent on the (+X) side of writing blocks 82 passed by an outlet 311 at the end on the (+X) side of the nozzle unit 31 in the first main scanning.

In repetition of the fifth and subsequent main scannings and sub scannings of the head 3, an amount of movement in the sub scanning is sequentially changed to amounts of movement in the sub scannings after the above first to fourth main scannings. That is to say, assuming that a is an integer which is equal to or greater than 0, amounts of movement in the sub scanning after (1+4α)th main scanning, (2+4α)th main scanning, (3+4α)th main scanning, and (4+4α)th main scanning are made equal to the amounts of movement in the sub scannings after the above first to fourth main scannings, respectively.

In the printer 1, the ejection control of ink is performed to each of the writing positions 81 passed by each of the outlets 311 while performing the sub scanning of the head 3, and thereby the ejection control of ink in the nozzle unit 31 is performed one time to each of the writing positions 81 (excluding writing positions 81 included in writing blocks 82 passed by 222 outlets 311 on the (−X) side in the nozzle unit 31 in the first main scanning) in the writing position arrangement 80 on the base member 9, and printing on the first base member 9 is completed.

When it is confirmed the next base member 9 to be processed exists (Step S20), the base member 9 held on the stage 21 is replaced with the next (second) base member 9 (Step S13) and the operations of the above Steps S14 to S17 and S19 are repeated (Step S18). In this manner, printing is performed on all the base members 9 to be processed.

Discussion will be made on temperature change of the stage 21 when printing on a plurality of base members 9 is repeated in the above basic operation. FIG. 8 is a graph showing an example of temperature change of the stage 21, and the vertical axis shows a temperature of the stage 21 and the horizontal axis shows time. In FIG. 8, arrows D1, D2, D3 and D4 respectively represent time periods where printing on the first to fourth base members 9 is performed (i.e., time periods where the operations of the above Steps S14 to S19 are performed) and arrows E1, E2 and E3 respectively represent time periods for replacing the first to third base members 9 with the next base member 9.

As shown by the solid line L11 in FIG. 8, the temperature of the stage 21 is controlled to a predetermined temperature θ1 (e.g., 20 degrees and hereinafter, referred to as “setting temperature θ1”) by the circulator 212 at the start time of printing. The temperature increases by irradiation with the UV light from the light irradiation part 38 during the time periods D1 to D4 in each of which printing on the base member 9 is performed, and the temperature decreases by the ambient temperature during the time periods E1 to E3 in each of which the base member 9 where printing is finished is replaced with the next base member 9. Actually, since temperature rise of the stage 21 is saturated at the temperature θ0 (e.g., 60 to 70 degrees), the temperature reaches the saturation temperature θ0 in printing of the third base member 9, and temperature change during each of time periods where printing of the fourth and subsequent base members 9 are performed is almost the same as that during the time period D4 in FIG. 8. The temperature change of the stage 21 shown in FIG. 8 is an example and the number of the base members 9 which are processed until the stage 21 reaches the saturation temperature θ0 varies according to various conditions. Temperature changes shown by the broken line in FIG. 8 will be described later.

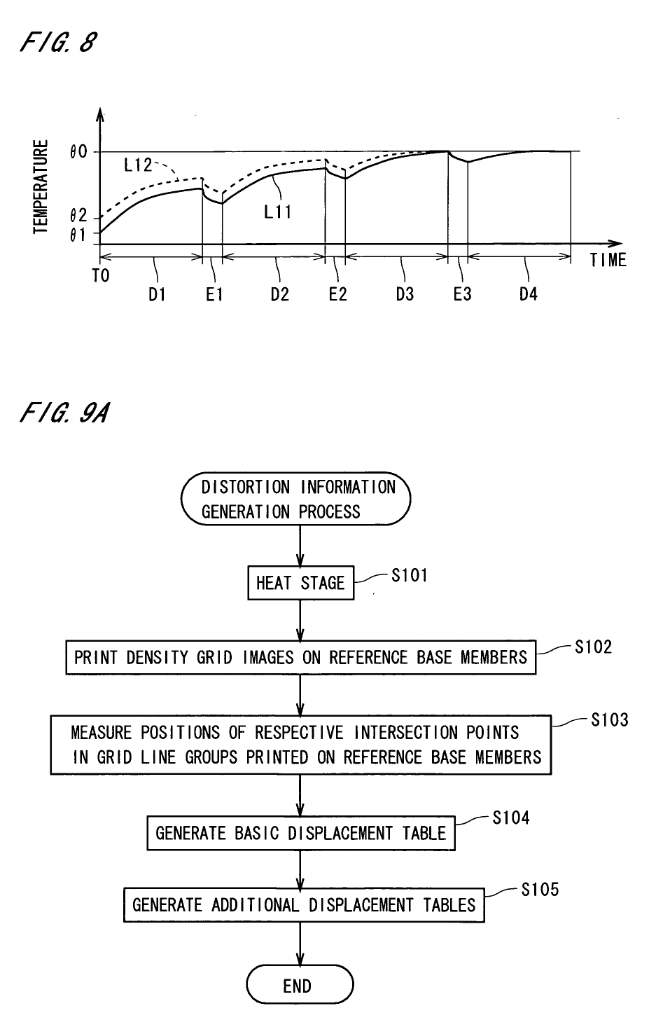

Next discussion will be made on a distortion information generation process which is performed as preparation of operations for actual printing in the printer 1. FIG. 9A is a flowchart showing a flow of process for generating distortion information, and FIG. 9B is a conceptual view showing summary of the distortion information generation process. The following description is made along FIG. 9A, referring to FIG. 9B as appropriate. The distortion information is used in acquiring distortion (assumed distortion (expansion and contraction)) of the base member 9 caused by light emitted from the light irradiation part 38 in the actual printing which is discussed later.

In generation of the distortion information, first, the head 3 repeatedly performs main scanning and sub scanning relative to the stage 21 (on which the base member 9 is not placed) in the printer 1 in a state where UV light is emitted from the light irradiation part 38 of the head 3, to thereby heat the whole stage 21 (Step S101). With this operation, the stage 21 gets close to the saturation temperature and becomes a state which is close to the latter part of the time period D4 in FIG. 8. Subsequently, with respect to each color of CMYK, data of a plurality of uniform density images with different densities are prepared (As discussed later, the plurality of uniform density images have grid-like lines and hereinafter, referred to as “density grid images”.).

FIGS. 10A to 10E are views showing a plurality of density grid images 72A to 72E of one color and respectively correspond to densities (percentages of writing) of 0%, 25%, 50%, 75% and 100%. In FIGS. 10B to 10E, differences among densities of the images are represented by changing the distance between the diagonal lines.

The size of the density grid images 72A to 72E corresponds to the size (number of pixels) of an area which can be printed on the base member 9 (the later-discussed thermal expansion of the base member 9 is omitted). As shown in FIGS. 10A to 10E, each of the density grid images 72A to 72E is divided into a plurality of divided areas 721 of m rows and n columns. Actually, each of the density grid images 72A to 72E has a set of a plurality of line segments 720 (hereinafter, referred to as “grid line group 720”) which are arranged in grid shape so as to partition the plurality of divided areas 721 and are parallel to the x direction corresponding to the X direction or the y direction corresponding to the Y direction. In the density grid images 72A to 72C with densities of 0%, 25% and 50% in FIGS. 10A to 10C, a density of the grid line group 720 is made to 100%, and in the density grid images 72D and 72E with densities of 75% and 100% in FIGS. 10D and 10E, a density of the grid line group 720 is made to 0%. Similarly to Steps S13 to S19 in the above-discussed basic operation, the plurality of density grid images 72A to 72E are printed on a plurality of base members for reference (hereinafter, referred to as “reference base members”) (Step S102).

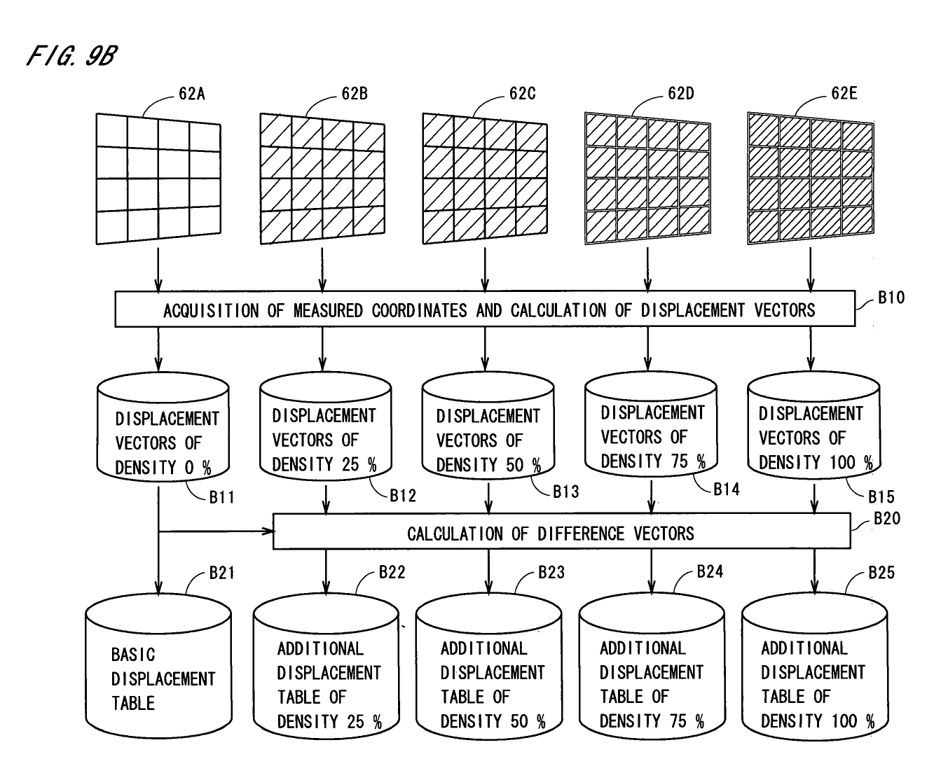

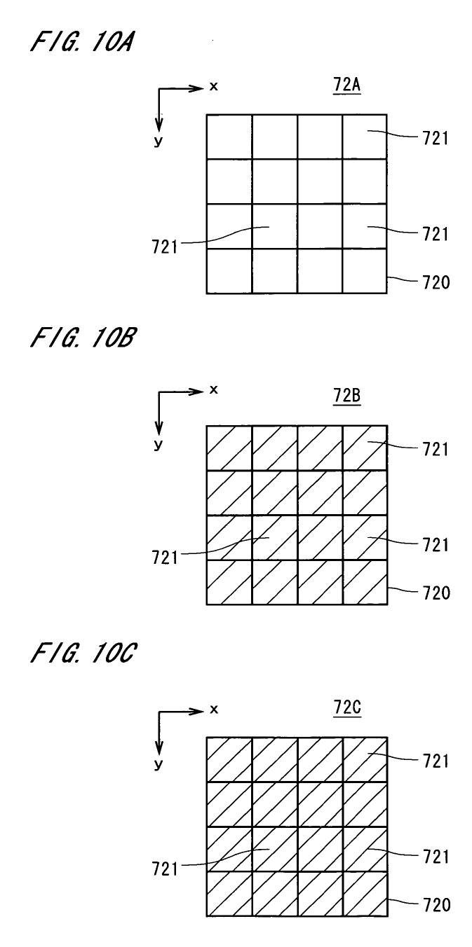

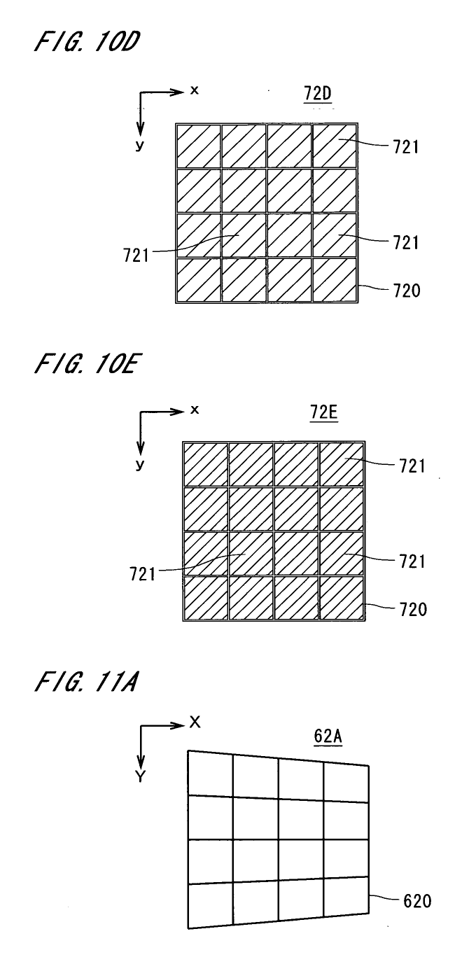

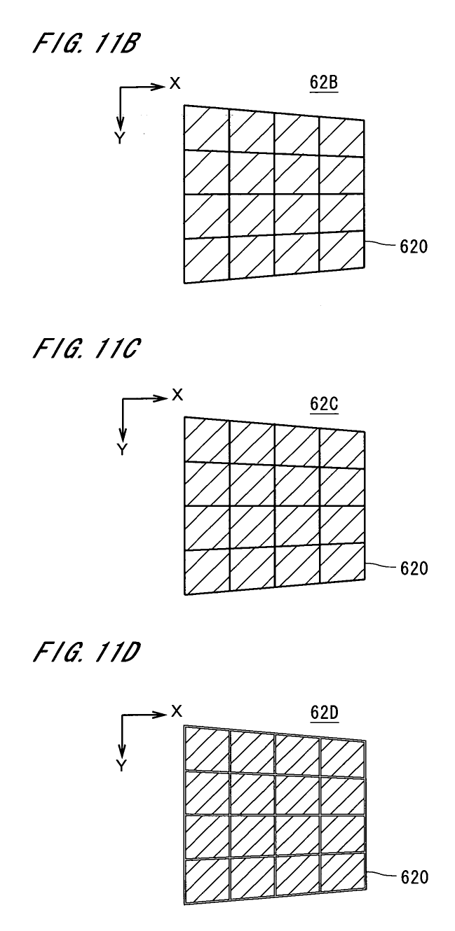

FIGS. 11A to 11E are views showing density grid images 62A to 62E printed on the reference base members and respectively correspond to densities of 0%, 25%, 50%, 75% and 100%. In FIGS. 11B to 11E, differences among densities of the images printed on the reference base members are represented by changing the distance between the diagonal lines. Also, in FIGS. 11A to 11E, the grid line group which is actually written on the reference base member is represented by the reference sign 620.

As described earlier, since the temperature of the stage 21 is close to the saturation temperature immediately before printing the density grid image, temperature change of the stage 21 is the same as that of the line L11 in the time period D4 of FIG. 8 in printing of each density grid image on the reference base member, and the temperature of the stage 21 increases according to passage of time after start of printing and reaches the saturation temperature. Therefore, the reference base member is expanded according to passage of time immediately after being placed on the stage 21, and the density grid image is printed on the reference base member in a state where the reference base member is expanded (the state including the process of being expanded). As a result, the image printed on the reference base member is distorted in a state where the reference base member is back to room temperature (a state where the reference base member is contracted) after printing. Specifically, since the stage 21 almost reaches the saturation temperature in printing to a part on the (+X) side on the reference base member, a part of the density grid image is printed in a state where the reference base member largely extends in the X direction and the Y direction and the part of the density grid image on the reference base member is largely contracted in the room temperature. As shown in FIGS. 11A to 11E, each outside shape of the density grid images 62A to 62E printed on the reference base members becomes an approximately trapezoid whose width in the Y direction is narrower toward the (+X) direction, and the grid line group 620 is distorted in a similar fashion. Actually, the base member 9 is heated by the UV light emitted from the light irradiation part 38 according to a density of the density grid image and therefore, shapes of the grid line groups 620 of the density grid images 62A to 62E are different from one another.

Subsequently, in each of the density grid images 62A to 62E printed on the reference base members, positions of intersection points in the grid line group 620 (i.e., points corresponding to grid points in each of the density grid images 62A to 62E) are measured by an external measurement apparatus (Step S103). At this time, in the measurement apparatus, two directions which correspond to the X direction and the Y direction of the printer 1 (hereinafter, similarly referred to as “X direction” and “Y direction”) are defined, and coordinates in the X direction and the Y direction of each intersection point of the grid line group 620 (hereinafter, referred to as “measured coordinates”) is measured with reference to the corner on the (−X) side and the (−Y) side of the reference base member and inputted to the operation part 51 through the input part of the computer 5.

In the operation part 51, with reference to the corner on the (−X) side and the (−Y) side of the reference base member, ideal coordinates of each intersection point of the grid line group on the reference base member, that is to say, assuming that distortion of the reference base member does not occur in printing a density grid image on the reference base member, coordinates of an intersection point (hereinafter, referred to as “standard intersection point”) of a grid line group (hereinafter, referred to as “standard grid line group”) of the density grid image printed on the reference base member are also stored in advance. A difference in each of the X direction and the Y direction between measured coordinates of each intersection point of the grid line groups 620 acquired from the density grid images 62A to 62E printed on the reference base members and coordinates of a standard intersection point corresponding to the measured coordinates is obtained as a distortion amount relative to the standard intersection point in each of the density grid images 62A to 62E. In other words, obtained is a vector from each standard intersection point of the standard grid line group to an intersection point corresponding to the standard intersection point (the intersection point can be regarded as a standard intersection point which is moved) in each of the density grid images 62A to 62E on the reference base members. The vector represents displacement (positional difference) from an ideal position (the standard intersection point) of each intersection point in the density grid images 62A to 62E on the reference base members, and hereinafter referred to as a “displacement vector”. The displacement vector is used synonymously with a distortion amount in the X direction and the Y direction relative to the standard intersection point.

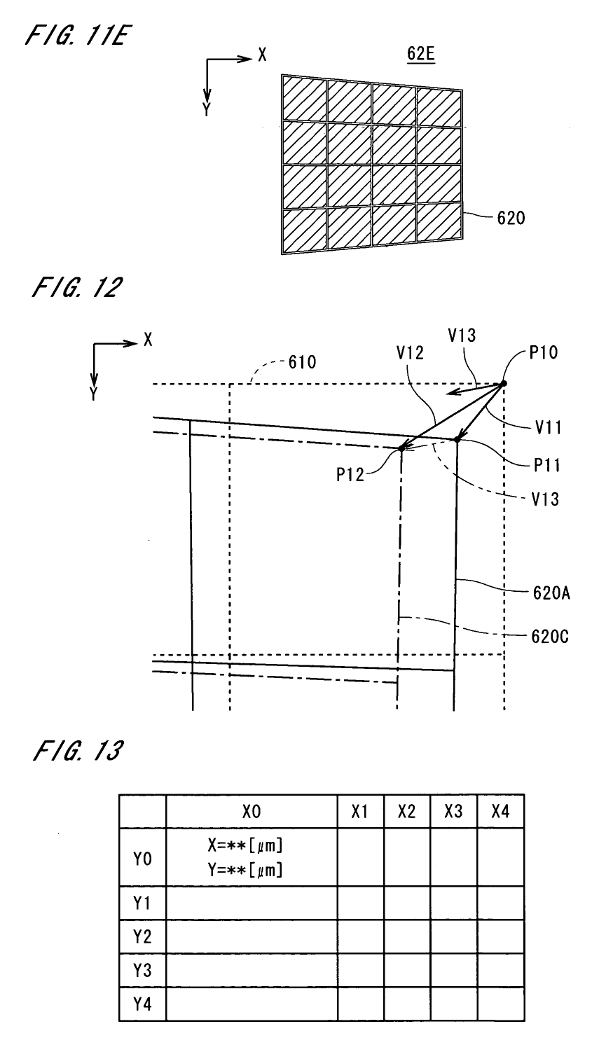

FIG. 12 is a view showing a grid line group 620A of the density grid image 62A of 0% and in FIG. 12, the standard grid line group 610 and a grid line group 620C of the density grid image 62C of 50% are also shown by broken lines and one-dot chain lines, overlapping with the grid line group 620A. Looking at the standard intersection point P10 of the standard grid line group 610 in FIG. 12, in the grid line group 620A, a vector from the standard intersection point P10 of the standard grid line group 610 to the corresponding intersection point P11 (the standard intersection point after displacing) is acquired as a displacement vector V11 relative to the standard intersection point P10 in the density grid image 62A of 0%. In the grid line group 620C, a vector from the standard intersection point P10 of the standard grid line group 610 to the corresponding intersection point P12 is acquired as a displacement vector V12 relative to the standard intersection point P10 in the density grid image 62C of 50%.

In the upper part of FIG. 9B, the above operation for obtaining a displacement vectors relative to respective standard intersection points with respect to densities corresponding to the density grid images 62A to 62E is conceptually shown by providing a block B10 filled in with “acquisition of measured coordinates and calculation of displacement vectors” between the density grid images 62A to 62E and a block B11 filled in with “displacement vectors of density 0%”, a block B12 filled in with “displacement vectors of density 25%”, a block B13 filled in with “displacement vectors of density 50%”, a block B14 filled in with “displacement vectors of density 75%”, and a block B15 filled in with “displacement vectors of density 100%”.

In the operation part 51, a table showing displacement vectors relative to respective standard intersection points in the density grid image 62A of 0% (hereinafter, the displacement vectors are referred to as “basic displacement vectors”) is generated as a basic displacement table as shown in FIG. 13 (Step S104). In FIG. 13, a displacement vector relative to the corresponding standard intersection point is described in a column specified by a position in the X direction (X0, X1, . . . , X4) and a position in the Y direction (Y0, Y1, . . . , Y4).

In the transparent reference base member on which the density grid image 62A of 0% is printed, the reference base member is directly heated by the UV light emitted from the light irradiation part 38 at a small degree, however, since the UV light are absorbed in the stage 21, the stage 21 is heated and the reference base member is heated indirectly. Therefore, it is thought that the basic displacement vector represents distortion of the base member 9 (displacement of the standard intersection point), which is mainly caused by temperature rise of the stage 21.

In the operation part 51, obtained is a difference vector indicating a difference between a displacement vector relative to each standard intersection point in the other density grid images 62B to 62E (i.e., the density grid images 62B to 62E of 25%, 50%, 75% and 100%) and the corresponding basic displacement vector. For example, in the grid line group 620C of the density grid image 62C in FIG. 12, a difference vector V13 indicating a difference between the displacement vector V12 relative to the standard intersection point P10 and the corresponding basic displacement vector V11 is obtained. The reference base member (ink on the reference base member) is directly heated by the UV light emitted from the light irradiation part 38 mainly depending on color or density (distribution) of ink ejected on the reference base member and it is thereby thought the difference vector V13 indicates distortion of the base member 9 which occurs in addition to distortion of the base member 9 caused by temperature rise of the stage 21. That is to say, the difference vector V13 is regarded as indicator of displacement of the standard intersection point P10 which is added to the corresponding basic displacement vector V11, and the difference vector is hereinafter referred to as an “additional displacement vector”. In FIG. 12, the displacement vector V13 is shown by a double-dashed line with the intersection point P11 directed by the basic displacement vector V11 as a starting point (i.e., having a starting point which is the intersection point P11). In this manner, a plurality of additional displacement vectors relative to a plurality of standard intersection points are acquired in each of the density grid images 62B to 62E of 25%, 50%, 75% and 100%, and a table representing the plurality of additional displacement vectors is generated as an additional displacement table (Step S105).

In the lower part of FIG. 9B, the block B11 and a block B21 filled in with “basic displacement table” are connected with an arrow, which conceptually shows the basic displacement table is directly derived from the displacement vectors relative to the standard intersection points in the density grid image 62A of 0%. A block B20 filled in with “calculation of difference vectors” is provided between the blocks B12 to B15 and a block B22 filled in with “additional displacement table of density 25%”, a block B23 filled in with “additional displacement table of density 50%”, a block B24 filled in with “additional displacement table of density 75%”,% and a block B25 filled in with “additional displacement table of density 100%”, and the block B11 is connected to the block B20 with an arrow, to thereby conceptually show the additional displacement tables of density 25%, 50%, 75% and 100% are derived on the basis of the displacement vectors of density 25%, 50%, 75% and 100% and the displacement vectors of 0%.

Though the density grid images 62B to 62E of 25%, 50%, 75% and 100% are printed on the reference base members with respect to each color of CMYK, the density grid image 62A of 0% is printed for only one color (for example, K). Therefore, the plurality of additional displacement tables for each color of CMYK and one basic displacement table are generated through the above processes and a set of these tables is used as the distortion information.

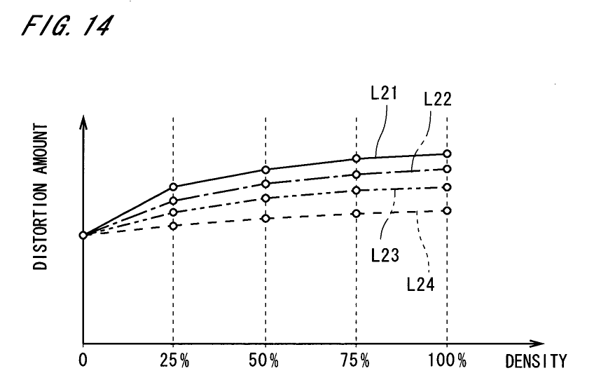

FIG. 14 is a graph showing a relationship between a density and a distortion amount (a size in a direction of a displacement vector) relative to a standard intersection point in a density grid image. The horizontal axis is a density and the vertical axis is a distortion amount in FIG. 14. Changes of distortion amounts in the density grid images of colors of K, C, M and Y are shown by lines L21, L22, L23 and L24, respectively. As shown in FIG. 14, a distortion amount increases as a density of each color is higher, and as a density of an image printed on the base member 9 is higher, a distortion amount of the base member 9 in printing increases. In other words, the distortion amount is added from a distortion amount of the density grid image of 0% according to a density of an image printed on the base member 9.

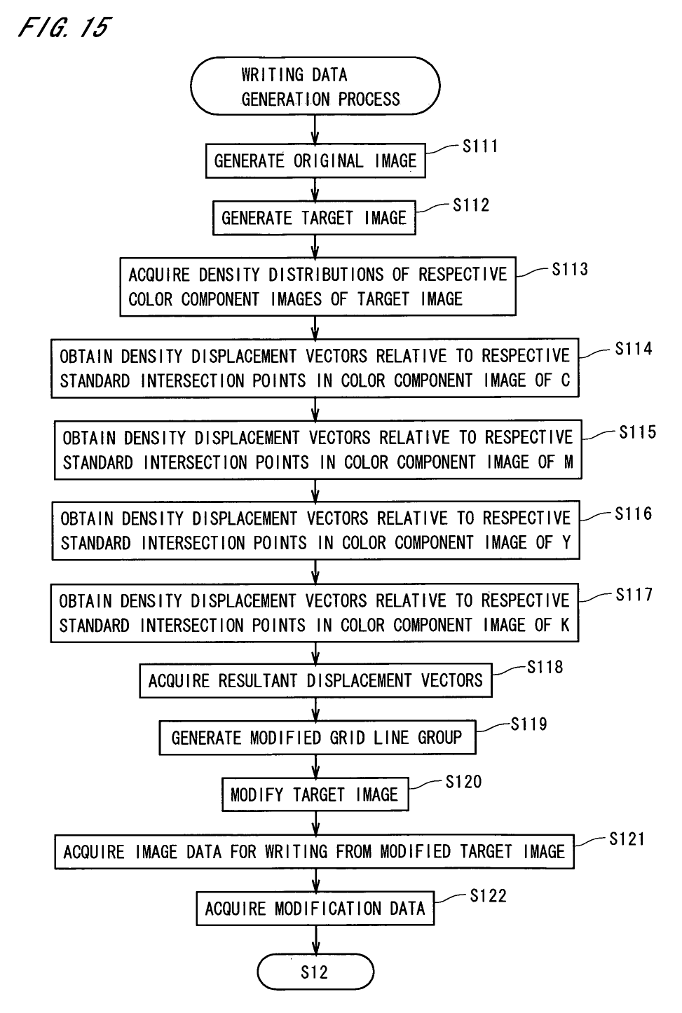

Next discussion will be made on an operation for an actual printing in the printer 1, referring to Steps S0 to S20 of FIG. 5. In the printer 1, first, distortion information 521 which is previously generated in the above-discussed distortion information generation process is stored and prepared in the storage part 52 (Step S10). A plurality of distortion informations 521 are shown in FIG. 4, but only one distortion information 521 is used in the present preferred embodiment. Subsequently, writing data used in the actual printing is generated on the basis of the distortion information and the image to be printed on the base member 9 (Step S11). FIG. 15 is a flowchart showing a flow of process for generating the writing data and shows a process performed in Step S11 of FIG. 5.

In generation of the writing data, first, RIP (Raster Image Processing) is performed on a color image to be printed in the operation part 51 of the computer 5, and an image with the number of pixels according to a resolution of printing (the number of dots per unit length in each direction) is generated so as to be printed on the base member 9 in a desired size (i.e., the image is an original image in the following processes and hereinafter referred to as “original image”) (Step S111). Actually, the original image is a set of a plurality of color component images which respectively correspond to the plurality of colors of CMYK.

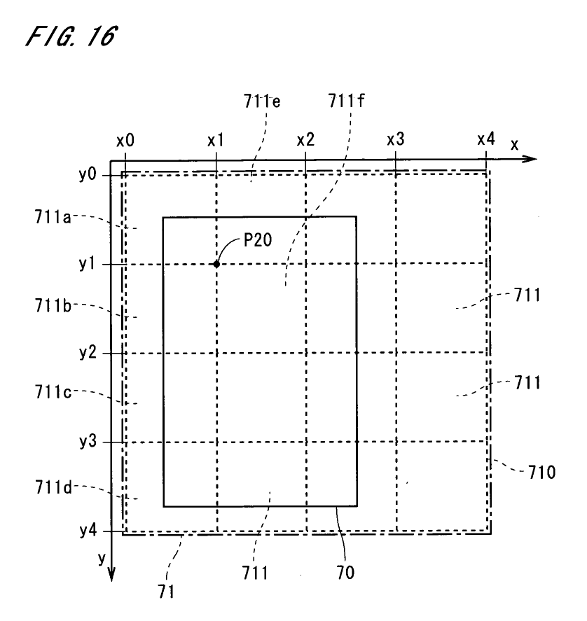

FIG. 16 is a view showing the outside shape of the original image 70. The original image 70 is arranged in an area which is defined in the x direction corresponding to the X direction and the y direction corresponding to the Y direction, similarly to the density grid images 72A to 72E. After generation of the original image 70, a position where the original image 70 has to be arranged is determined relatively to a line group 710 which corresponds to the standard grid line group 610 on the base member 9 (the line group 710 is shown by broken lines in FIG. 16 and hereinafter, referred to as “standard grid line group 710”). The position of the original image 70 relative to the standard grid line group 710 is determined, for example, by giving an input through the input part of the control part 5 by an operator. After the position of the original image 70 is determined, an image which corresponds to a rectangle around the whole standard grid line group 710 (i.e., the outermost rectangle) and has pixel values corresponding to a density of 0% in an area other than the original image 70 is generated as a target image 71 (whose outside shape is shown by a one-dot chain line in FIG. 16) in the operation part 51 (Step S112). Since the original image 70 is a set of the plurality of color component images which respectively correspond to the plurality of colors of CMYK, the target image 71 is actually a set of a plurality of color component images which respectively correspond to the plurality of colors of CMYK.

As shown in FIG. 16, the target image 71 is divided into a plurality of divided areas 711 (hereinafter, referred to as “standard divided areas 711”) by the standard grid line group 710, and an average value of densities in each standard divided area 711 (hereinafter, referred to as “an average density of the standard divided area 711”) is acquired in each color component image of the target image 71 in the operation part 51. With this operation, a density distribution where the standard divided area 711 according to the standard grid line group 710 is a unit area is acquired in each color component image of the target image 71 (Step S113).

Subsequently, in the operation part 51, obtained are amounts of modification for distorting the target image 71 in accordance with distortion of the base member 9 in the actual printing. The amounts of modification of the target image 71 are obtained by calculating a vector (a density displacement vector discussed later) which should be added to the basic displacement vector for each standard intersection point shown by the basic displacement table of the distortion information 521, in accordance with the density distribution of each color component image in the target image 71. Though the following discussion will be made on the color component image of one color of the target image 71, the color component images of the other colors are processed in the same manner as discussed later.

When a vector to be added to the basic displacement vector is obtained, first, an evaluation value concerning a density for each standard divided area 711 which is derived from an average density of the standard divided area 711 and average densities of other standard divided areas 711 (or an average density of another standard divided area 711) is calculated. As discussed earlier, since the head 3 performs main scanning relatively to the base member 9 in the (+Y) direction and performs sub scanning in the (+X) direction every time main scanning is performed, an evaluation value of each standard divided area 711 is acquired as a weighted average of an average density of the standard divided area 711 and average densities of standard divided areas 711 which correspond to areas where writing has already performed along the moving path of the head 3 relative to the base member 9 in writing of an area on the base member 9 corresponding to the standard divided area 711. For example, in a standard divided area 711a on the (−x) side and the (−y) side of FIG. 16, an average density of the standard divided area 711a is used as an evaluation value. An evaluation value of a standard divided area 711b on the (+y) side of the standard divided area 711a is a weighted average of an average density of the standard divided area 711a and an average density of the standard divided area 711b, and an evaluation value of a standard divided area 711c on the (+y) side of the standard divided area 711b is a weighted average of the average density of the standard divided area 711a, the average density of the standard divided area 711b, and an average density of the standard divided area 711c. Also, an evaluation value of a standard divided area 711e on the (+x) side of the standard divided area 711a is a weighted average of the average density of the standard divided area 711a, the average density of the standard divided area 711b, the average density of the standard divided area 711c, an average density of a standard divided area 711d on the (+y) side of the standard divided area 711c, and an average density of the standard divided area 711e. A weighted coefficient in obtaining an evaluation value of each standard divided area 711 by a weighted average is determined on the basis of positions of other standard divided areas 711 relative to the standard divided area 711 (for example, a distance between the standard divided areas 711 or the like).

After calculation of the evaluation value concerning the density of each standard divided area 711, an evaluation density which affects each standard intersection point of the standard grid line group 710 is obtained. An evaluation density of each standard intersection point is obtained as an average value (which may be a weighted average) of evaluation values of standard divided areas 711 which have the standard intersection point on their edges. For example, an evaluation density of the standard intersection point P20 in coordinates (x1, y1) of FIG. 16 is an average value of evaluation values of the standard divided area 711a which is upper left of the standard intersection point P20 (on the (−x) side and the (−y) side), the standard divided area 711b which is lower left (on the (−x) side and the (+y) side), the standard divided area 711e which is upper right (on the (+x) side and the (−y) side), and a standard divided area 711f which is lower right (on the (+x) side and the (+y) side). An evaluation density of a standard intersection point (excluding four corners) on the outermost rectangle of the standard grid line group 710 is an average value of evaluation values of two standard divided areas 711 which have the standard intersection point on their edges, and an evaluation density of a standard intersection point corresponding to a vertex of the outermost rectangle of the standard grid line group 710 is an evaluation value of one standard divided area 711 having the standard intersection point on its edge.

When an evaluation density α% of a standard intersection point is larger than 0% and is equal to or smaller than 25% (i.e., 0<α≦25), a density displacement vector V which should be added to a basic displacement vector of the standard intersection point is obtained by Eq. 1, where V_{D25} is the corresponding additional displacement vector in the additional displacement table of 25%.

V=V_{D25}×α/25 Eq.1

When the evaluation density α% of the standard intersection point is larger than 25% and is equal to or smaller than 50% (i.e., 25<α≦50), the density displacement vector V of the standard intersection point is obtained by Eq. 2, where V_{D25} is the corresponding additional displacement vector in the additional displacement table of 25% and V_{D50} is the corresponding additional displacement vector in the additional displacement table of 50%.

V=(V_{D50}−V_{D25})×(α−25)/25+V_{D25} Eq. 2

Also, when the evaluation density α% of the standard intersection point is larger than 50% and is equal to or smaller than 75% (i.e., 50<α≦75), the density displacement vector V of the standard intersection point is obtained by Eq. 3, where V_{D50} is the corresponding additional displacement vector in the additional displacement table of 50% and V_{D75} is the corresponding additional displacement vector in the additional displacement table of 75%.

V=(V_{D75}−V_{D50})×(α−50)/25+V_{D50} Eq. 3

When the evaluation density α% of the standard intersection point is larger than 75% and is equal to or smaller than 100% (i.e., 75<α≦100), the density displacement vector V of the standard intersection point is obtained by Eq. 4, where V_{D75} is the corresponding additional displacement vector in the additional displacement table of 75% and V_{D100} is the corresponding additional displacement vector in the additional displacement table of 100%.

V=(V_{D100}−V_{D75})×(α−75)/25+V_{D75} Eq. 4

When the evaluation density α% of the standard intersection point is 0%, the density displacement vector is 0.

Actually, the above process for obtaining the density displacement vector of the standard intersection point in the standard grid line group 710 is performed to each of color component images of C, M, Y and K of the target image, and four density displacement vectors are acquired from the color component images of CMYK with respect to each standard intersection point (Steps S114 to S117).

With respect to one color, if a density grid image having the same density distribution (density distribution where a divided area is a unit) as a color component image of the target image 71 is printed on the base member 9 (a density of each divided area is an average density of the corresponding standard divided area 711 of the color component image in the target image 71), it is assumed that an intersection point of a grid line group in the density grid image corresponding to each standard intersection point of the standard grid line group on the base member 9 is written at a position designated by a vector, which is obtained by synthesizing a basic displacement vector and a density displacement vector, with the standard intersection point as a starting point (i.e., having a starting point which is the standard intersection point). In other words, it is thought that each standard intersection point on the base member 9 moves to a position which is designated by the reverse vector of the vector with the standard intersection point as a starting point in printing an area close to the position since the base member 9 is distorted by temperature rise caused by irradiation with the UV light from the light irradiation part 38. Therefore, the distortion information 521 is considered to substantially represent, with respect to each color of CMYK, a relationship between a density distribution of an image printed on the base member 9 and distortion of the base member 9 by temperature rise caused by irradiation with the UV light from the light irradiation part 38.

Since the color component images of CMYK in the target image 71 are actually printed on the same base member 9 in parallel with one another, the basic displacement vector and the four density displacement vectors of CMYK are synthesized in each standard intersection point of the standard grid line group 710 and a resultant displacement vector representing displacement, which is assumed in this case, of the corresponding standard intersection point on the base member 9 is acquired (Step S118).

FIG. 17 is a view showing one standard divided area 711 of the standard grid line group 710. In standard intersection points P30, P40, P50, P60 of the four corners of the standard divided area 711 shown in FIG. 17, vectors V31, V41, V51, V61 correspond to the resultant displacement vectors, and a plurality of positions P31, P41, P51, P61 which are respectively designated by the vectors V31, V41, V51, V61 with the standard intersection points P30, P40, P50, P60 as starting points correspond to positions after displacing of standard intersection points on the base member 9 assumed in printing the target image 71. Therefore, a square area 712 (shown by a broken line in FIG. 17), which is formed by linking the plurality of positions P31, P41, P51, P61 respectively designated by the vectors V31, V41, V51, V61, can be considered to be formed on the base member 9 correspondingly to the standard divided area 711, if a plurality of colors of density grid images having the same density distributions as the plurality of color component images of the target image 71 are printed on the same base member 9 in parallel with one another.

In the operation part 51, the reverse vectors of the vectors V31, V41, V51, V61 in the standard intersection points P30, P40, P50, P60 of the standard grid line group 710 are obtained as vectors (hereinafter, referred to as “modification vectors”) Vr31, Vr41, Vr51, Vr61 which represent amounts of modification in the x direction and the y direction for distorting an image to be written, in accordance with distortion of the base member 9 in the actual printing. In this manner, generated is a grid line group (hereinafter, referred to as “modified grid line group”) having new intersection points P32, P42, P52, P62 which are positions designated by the corresponding modification vectors Vr31, Vr41, Vr51, Vr61 with the standard intersection points P30, P40, P50, P60 of the standard grid line group 710 as starting points (Step S119). In FIG. 17, only one divided area 731 of the modified grid line group is shown by a double-dashed line. In the following description, the divided area defined by the modified grid line group is referred to as a “modified divided area”.

Subsequently, in the operation part 51, a part of each standard divided area 711 in the plurality of color component images of the target image 71 is distorted (i.e., pixels are added or deleted) in the x direction corresponding to the sub scan direction (X direction) in accordance with the modified divided area 731 of the modified grid line group, to thereby modify the target image (Step S120).

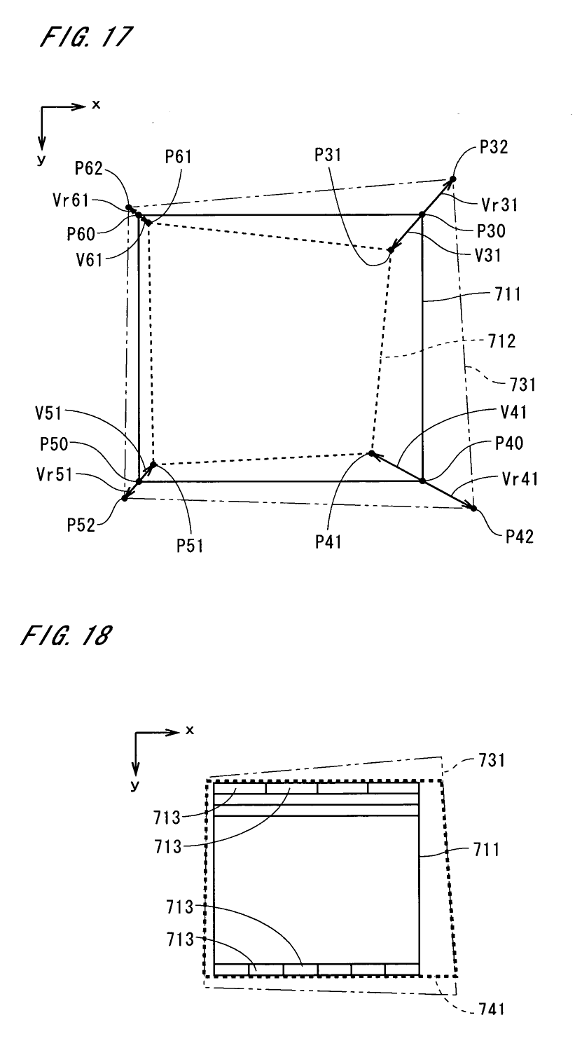

FIG. 18 is a view for explaining modification of the target image. In the operation part 51, in a case where the modified divided area 731 in the modified grid line group is distorted as shown by a double-dashed line in FIG. 18, the modified divided area 731 is contracted in the y direction and the upper and lower ends of the modified divided area 731 are made to coincide with the standard divided area 711 (shown by a solid line in FIG. 18) in the standard grid line group, to generate an area 741 shown by a thick broken line in FIG. 18. In the printer 1, since the number of pixels in the x and y directions in the standard divided area 711 is known, an integer part of a value obtained by multiplying a value, which is obtained by dividing, a difference of a length in the x direction between the area 741 and the standard divided area 711 by a length in the x direction of the standard divided area 711, with the number of pixels in the x direction in the standard divided area 711, is obtained as the number of pixels to be added in each position in the y direction.

As discussed earlier, since the target image 71 is fixed relatively to the standard grid line group 710 (see FIG. 16), pixels of the number to be added are added to each position in the y direction in a part included in the standard divided area 711 of (each color component image of) the target image 71. For example, in a case where the number of pixels to be added is four in a position at the end on the (−y) side of the standard divided area 711 of FIG. 18, a group of pixels arranged in the x direction is equally divided into four blocks 713 and adjacently to one pixel of a predetermined position (for example, the central portion in the x direction) in each block 713, a pixel of the same value is added. Also, in a case where the number of pixels to be added is six in a position at the end on the (+y) side of the standard divided area 711 of FIG. 18, the group of pixels arranged in the x direction is equally divided into six blocks 713 and adjacently to one pixel of the predetermined position in each block 713, a pixel of the same value is added. As a result, a pixel value of a pixel corresponding to each position in the area 741 is determined.

In the area where the modified divided area 731 is contracted in the y direction to coincide its upper and lower ends with the standard divided area 711, if there is a part whose width in the x direction is narrower than that of the standard divided area 711, the number of pixels to be added in the above process is obtained as a negative value. In this case, the group of pixels arranged in the x direction is equally divided into blocks of the number of the absolute value of the negative value and one pixel in each block is deleted.

As discussed above, in the operation part 51, the plurality of color component images in the target image 71 are linearly modified in the same manner on the basis of the distortion information 521 and a plurality of density distributions of the plurality of color component images, to acquire a modified target image. In each color component image of the modified target image, pixels which exist outside of the outermost rectangle of the standard grid line group 710 are deleted, pixels of a pixel value corresponding to a density of 0% are added to a part where pixels are lost inside of the rectangle, and the number of pixels of the modified target image is made to that corresponding to the outermost rectangle of the standard grid line group 710 (the same as in the second preferred embodiment discussed later).

Then, image data for writing is acquired by comparing each pixel value of the modified target image with an element value corresponding to the pixel value in a dither matrix which is prepared (i.e., by performing a halftone dot meshing (dither processing) to the modified target image) (Step S121).

After acquisition of the image data for writing, modification data used in shifting ejection timing of ink in main scanning of the head 3 is acquired (Step S122). Specifically, in each position in the x direction, obtained is a value obtained by dividing a length in the y direction of the modified divided area 731 by a length in the y direction of the area 741 (or the standard divided area 711) (the value is used for changing an ejection cycle of ink in printing discussed later, and hereinafter referred to as “cycle shift value”). Actually, the cycle shift value can be acquired when the modified divided area 731 is contracted in the y direction to generate the area 741 in Step S120.

Also, in each position in the x direction, a position of an edge on the (−y) side of the modified divided area 731 is specified (the position corresponds to a position where change of the ejection cycle of ink is started in printing discussed later, and the position is hereinafter referred to as “shift start position”). Actually, since a plurality of modified divided areas 731 are arranged in the y direction, a plurality of combinations of the shift start position and the cycle shift value are acquired in each position in the x direction to be stored as the modification data. As discussed above, writing data including the image data and the modification data is acquired in the operation part 51.

After acquisition of the writing data, a process for heating the stage 21 is performed by the light irradiation part 38 (FIG. 5: Step S12). The light source 39 for emitting UV light normally requires a certain degree of time until a distribution of intensity of the UV light becomes stable from the time when the light source 39 is brought into an ON state. Therefore, in the printer 1, the head 3 repeatedly performs main scanning and sub scanning relatively to the stage 21 (which may be the operations of Steps S13 to S19 in the above basic operation without ejection of ink from the head 3) in a state where the light source 39 is brought into the ON state to emit the UV light from the light irradiation part 38, to thereby heat the stage 21.

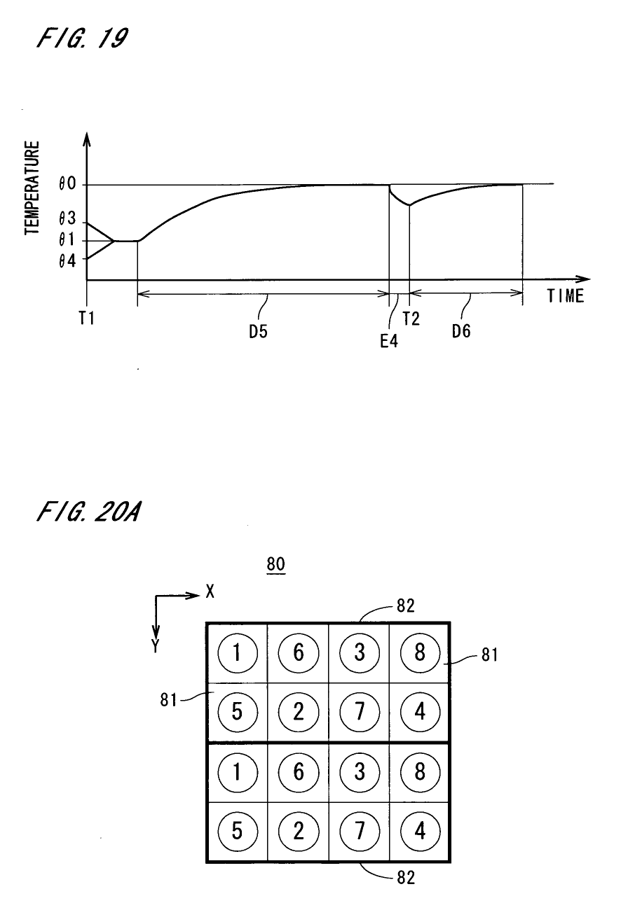

FIG. 19 is a graph showing temperature change of the stage 21, and the vertical axis shows a temperature of the stage 21 and the horizontal axis shows time. As described earlier, since the circulator 212 is provided in the printer 1, even if an ambient temperature of the printer 1 is a temperature θ3 which is higher than the setting temperature θ1 or a temperature θ4 which is lower than the setting temperature θ1 in a state where the whole printer 1 is not operated at time T1 of FIG. 19, the temperature of the stage 21 is immediately made to constant at the setting temperature θ1 by starting driving of the circulator 212. Then, the process for heating the stage 21 is performed by the light irradiation part 38 in a state where the stage 21 is the setting temperature θ1. The process is performed during a time period indicated by an arrow D5 of FIG. 19 and the temperature of the stage 21 reaches the saturation temperature θ0.

The base member 9 to be printed is placed and held on the stage 21 during a time period indicated by an arrow E4 of FIG. 19 (Step S113). During the time period E4 of FIG. 19, since the head 3 is withdrawn from above the stage 21 and the UV light are not applied to the stage 21, the temperature of the stage 21 decreases. Main scanning of the head 3 is started from time T2 of FIG. 19 (Step S14) and the ejection control of ink is performed to each of the writing positions 81 included in the writing position column passed by each outlet 311 of the head 3, in accordance with the image data included in the writing data (Step S115).

At this time, in the actual printing operation of the printer 1, the ejection timing of ink from each outlet 311 is controlled in accordance with the modification data included in the writing data. Specifically, when the outlet 311 disposed at each position in the X direction reaches the shift start position directed by the modification data, a cycle in the ejection control of ink is changed to a cycle which is obtained by multiplying the basic cycle with the cycle shift value. That is to say, in the writing position arrangement 80 of FIG. 6, the pitch in the Y direction of the writing positions 81 arranged in the Y direction is changed and the image in each position in the X direction is distorted in the Y direction. As discussed earlier, since the modification data includes the plurality of combinations of the shift start position and the cycle shift value in each position in the x direction, change of the cycle of ejection control of ink in each outlet 311 is performed a plurality of times in one main scanning. When the main scanning of the head 3 is finished (Step S16), the stage 21 moves to the initial position in the main scan direction (Step S17) and the head 3 performs sub scanning by the above-discussed distance (Steps S18, S19).

In this manner, the ejection control of ink in synchronization with the main scanning of the head 3 and the sub scanning of the head 3 are repeated (Steps S14 to S19) and the target image is printed on the whole base member 9 for a time period indicated by an arrow D6 of FIG. 19. At this time, temperature rise of the stage 21 in the time period D6 is the same as that in printing the density grid image on the reference base member in Step S102 of FIG. 9A.

Subsequently, when it is confirmed the next base member 9 to be processed exists (Step S20), the base member 9 held on the stage 2 is replaced with the next (second) base member 9 (Step S13) and the above operations of Steps S14 to S17 and S19 are repeated (Step S18). Temperature rise of the stage 21 during the printing of the second base member 9 is the same as that in the time period D6 of FIG. 19. After printing is performed to all the base members 9 to be processed in the same way, the actual printing in the printer 1 is completed (Step S20).

In a case where a base member on which an image is printed in a printer is used as a display panel of various apparatuses and a backlight for partial illumination is provided on a back side of the panel, it is required to prevent a relative positional error between the image printed on the base member and the backlight, the image printed on the base member therefore requires submillimeter (mm) accuracy of dimension, for example. Also, for improving productivity, an image corresponding to a plurality of display panels is actually printed on one base member. In such a case, when printing is performed on a base member with a high coefficient of thermal expansion in a general printer using light curable ink, it is not possible to accurately print an image on the base member because of distortion of the base member caused by irradiation with light from a light irradiation part (i.e., a printed image on the base member in room temperature is distorted) and the accuracy required for a display panel cannot be satisfied.

On the other hand, in the printer 1, the distortion information 521 representing the relationship between the density distribution of the image printed on the base member and distortion of the base member by temperature rise caused by irradiation with the light from the light irradiation part 38 is prepared and stored in the storage part 52 in advance, and the writing data is generated in the operation part 51 by modifying the target image 71, to be printed, on the basis of the distortion information 521 and the density distribution of the target image 71. The main body control part 40 controls relative movement of the head 3 by the stage moving mechanism 22 and the head moving mechanism 24, both of which are a scanning mechanism, and ejection of ink from the head 3 in synchronization with each other, in accordance with the writing data, and it is thereby possible to accurately print the target image 71 on the base member 9 (i.e., suppress distortion of the printed image on the base member 9 in the room temperature) in consideration of distortion of the base member 9 caused by irradiation with the light from the light irradiation part 38, in printing using the light curable ink.

In the printer 1, since the target image 71 is a set of the plurality of color component images and the plurality of color component images are modified in the same manner on the basis of the distortion information 521 and the plurality of density distributions of the plurality of color component images to acquire the writing data, it is possible to accurately print the color target image 71 on the base member 9.

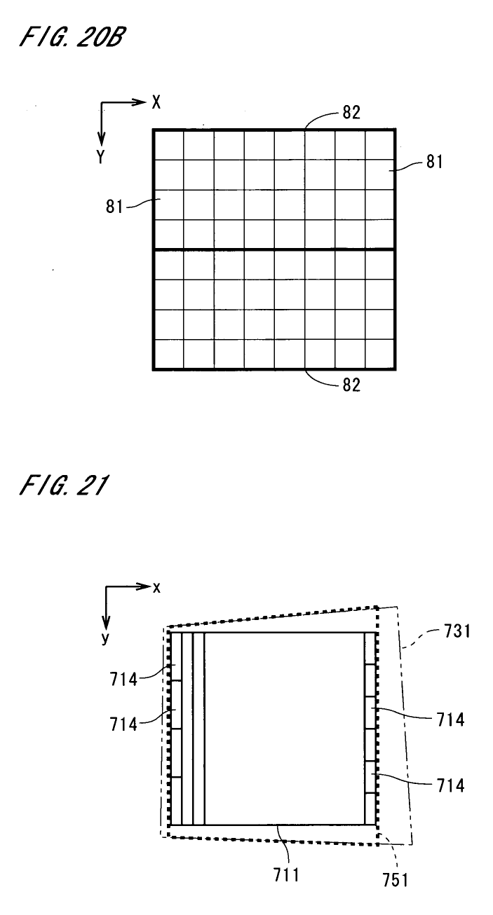

FIG. 20A is a view showing a part of the writing position arrangement 80 and circled numbers show the order of writing positions which become the target writing positions in each writing block 82. As shown in FIG. 20A, in the printer 1, ejection control of ink is performed to writing positions 81 arranged at a pitch corresponding to 600 dpi in the Y direction (the cycle of ejection control of ink based on the modification data is not changed), at a cycle corresponding to 300 dpi in one main scanning of the head 3, and a dot may be formed every other writing position 81 (that is to say, the interlaced process may be performed in the main scan direction and the sub scan direction). In this case, writing blocks 82 of two rows and four columns are defined in the writing position arrangement 80, and the head 3 passes each writing block 82 eight times to complete one ejection control of ink to each writing position 81 in the writing block 82.

In this case, a pitch in the row direction (X direction) of the writing positions 81 can be changed by changing the moving distance in the sub scan direction of the head 3. For example, color printing can be performed under the condition that the amount of movement in the row direction of the head 3 in Step S19 of FIG. 5 is made to a distance which is obtained by adding β/8 times the outlet pitch R (0≦β≦7) to an integral multiple of the outlet pitch R and the cycle (cycle before shifting) of ejection control of ink from each outlet 311 is made to a half of the basic cycle, so that resolutions in the row direction and the column direction are respectively made to 1200 dpi and 1200 dpi as shown in FIG. 20B (in this case, both of pitches in the row and column directions of the writing positions 81 are 21 μm). In this case, the head 3 passes each writing block 82 32 times, and one ejection control of ink to each writing position 81 in the writing block 82 is thereby completed.

In a case where the number of the writing positions 81 included in the writing block which is defined in the writing position arrangement 80 is changed as discussed above, temperature changes of the base member 9 and the stage 21 are different from those before being changed. Therefore, it is preferable that a plurality of distortion informations 521 (a part of the distortion informations is shown by a broken-line rectangle in FIG. 4) associated with the number of times where the head 3 passes each position on the base member 9 in main scanning in printing are prepared, and in generation of the writing data in Step S11 of FIG. 5, the distortion information corresponding to the writing block in the actual printing is selected from the plurality of distortion informations 521. As a result, it is possible to print the target image more accurately.

In the printer 1, the process for heating the stage 21 in Step S12 of FIG. 5 can be omitted. In this case, as shown in FIG. 8, temperature rise of the stage 21 in printing the initial base member 9 (the first to third base members 9 processed in the time periods D1 to D3) is different from that in printing the density grid image in generation of the distortion information (or that in printing the fourth to subsequent base members 9 processed in the time periods D4 or later of FIG. 8). Therefore, in a case where the process for heating the stage 21 by the light irradiation part 38 is omitted, it is preferable that a plurality of distortion informations which respectively correspond to prints of the first to third base members 9 are prepared and the distortion information is selected in accordance with the order of processing of each base member 9 to generate the writing data. Consequently, it is possible to print the target image on the base member 9 with accuracy.

In a case where the process for heating the stage 21 is omitted and the temperature control of the stage 21 by the circulator 212 is not performed, if a temperature of the stage 21 at the start time of the first printing (time T0 in FIG. 8) is θ2 because of influence of the ambient temperature as shown by a broken line L12 in FIG. 8, temperature change of the stage 21 at the printing of the first to third base members 9 changes from that indicated by the line L11. That is to say, temperature change of the stage 21 at the printing of the initial base member 9 becomes unstable. In this case, even if the distortion information corresponding to the initial base member 9 is prepared as described above, there is a possibility that a temperature of the stage 21 in the actual printing changes from θ2, to decrease the accuracy of a printed image on the base member 9. Therefore, in order to print a high accurate image on the base member 9 with high reproduction, it is required a temperature of the stage 21 is controlled at the predetermined temperature θ1 by the circulator 212 at the start time of the first printing (i.e., the circulator 212 functions as a temperature control part for controlling a temperature of the stage 21 to make the temperature at the start time of the first printing constant.).

Next discussion will be made on the second preferred embodiment of the present invention. In the present preferred embodiment, when the target image is modified in Step S120 of FIG. 15, additionally performed is a process where after pixels are added or deleted in the x direction, pixels are added or deleted in the y direction.

FIG. 21 is a view for explaining modification of the target image. In the operation part 51, in a case where the modified divided area 731 in the modified grid line group is distorted as shown by a double-dashed line in FIG. 21, the modified divided area 731 is contracted in the x direction, to generate an area 751 whose left and right ends are made to coincide with the standard divided area 711 (shown by a solid line in FIG. 21) in the standard grid line group, as shown by a thick broken line in FIG. 21. Similarly to the case of distorting the target image in the x direction, in each position in the x direction, an integer part of a value obtained by multiplying a value, which is obtained by dividing a difference of a length in the y direction between the area 751 and the standard divided area 711 by a length in the y direction of the standard divided area 711, with the number of pixels in the y direction in the standard divided area 711, is obtained as the number of pixels to be added. In a case where the number of pixels to be added is n in each position in the x direction in the standard divided area 711, a group of pixels arranged in the y direction is equally divided into n blocks 714 and adjacently to one pixel of a predetermined position in each block 714, a pixel of the same value is added. As a result, a pixel value of a pixel corresponding to each position in the area 751 is determined. If the number of pixels to be added is obtained as a negative value, the group of pixels arranged in the y direction in the standard divided area 711 is equally divided into blocks of the number of the absolute value of the negative value and one pixel of the predetermined position in each block is deleted.

After the target image is distorted in the x direction corresponding to the sub scan direction and the y direction corresponding to the main scan direction to be modified as discussed above, image data for writing is acquired by performing the halftone dot meshing to the modified target image (Step S121) and writing data used in the actual printing is generated (FIG. 5: Step S11). In the present preferred embodiment, a process for acquiring modification data in Step S122 is omitted.

After the stage 21 is heated (Step S112), the base member 9 is placed on the stage 21 (Step S13), the head 3 performs main scanning relative to the base member 9 in the main scan direction (Step S14) and ejection control of ink is performed to each of writing positions 81 included in a writing position column passed by each outlet 311 (Step S15).

At this time, the ejection control of ink in each outlet 311 is performed at the regular basic cycle in accordance with the writing data in the printer 1. After the main scanning of the head 3 is finished (Step S16), the stage 21 moves to the initial position in the main scan direction (Step S17) and the head 3 performs sub scanning by the above-discussed distance (Steps S18, S19). In this manner, the ejection control of ink in synchronization with the main scanning of the head 3 and the sub scanning of the head 3 are repeated (Steps S14 to S19) and the target image 71 is printed on the whole base member 9.

As discussed above, in the printer 1 according to the present preferred embodiment, the writing data used in the actual printing includes the image data which is acquired by distorting the target image in the direction corresponding to the sub scan direction and the direction corresponding to the main scan direction. Thus, it is possible to simplify control of the ejection timing of ink, and print the target image 71 on the base member 9 easily and accurately, in comparison with the printer 1 according to the first preferred embodiment where printing is performed while shifting the ejection timing of ink in the main scanning of the head 3. However, since the target image normally has an enormous amount of data, it is preferable that the modification data indicating shift of the ejection timing of ink in the main scanning of the head 3 is included in the writing data, in order to reduce an amount of computation in the operation part 51 and print the target image on the base member 9 at high speed and accurately.

Though the preferred embodiments of the present invention have been discussed above, the present invention is not limited to the above-discussed preferred embodiments, but allows various variations.

Although the density grid images each having the plurality of divided areas are printed on the reference base members in generation of the distortion information in the above preferred embodiments, there may be a case where grid line groups only showing the outermost rectangles are used as the grid line groups of the density grid images of respective colors, and basic displacement vectors and additional displacement vectors relative to respective standard intersection points which are vertexes of the rectangles are acquired. In this case, density displacement vectors of the standard intersection points are obtained on the basis of average densities of the whole color component images of the target image and a modified grid line group is acquired on the basis of the density displacement vectors to generate writing data, and then the target image is printed on the base member 9 with high accuracy.

As discussed above, in the printer 1, the distortion information is prepared as one representing the relationship in each color between the average density or the density distribution of the image printed on the base member 9 and distortion of the base member 9 by temperature rise caused by irradiation with the UV light from the light irradiation part 38, the writing data is generated on the basis of the distortion information and the average densities or the density distributions of respective color component images of the target image, and it is therefore possible to accurately print the color target image on the base member 9 in consideration of distortion of the base member 9 caused by irradiation with the UV light from the light irradiation part 38. However, in order to obtain the writing data with high accuracy and print the target image on the base member 9 with accuracy, it is preferable the distortion information is generated by printing the density grid images each having the plurality of divided areas on the reference base members and the writing data is generated on the basis of density distribution which is acquired by obtaining densities of the plurality of divided areas of the target image. In the density grid image, the number of divided areas divided by the grid line group may be changed according to the accuracy required in the image printed in the printer 1, the number of times where the head 3 passes each position on the base member 9 in printing, or the like.

As discussed later, in a case where only an outer part of the base member 9 is held, a case where color of the base member is black, or the like, there is no concept in the printer that light emitted from the light irradiation part 38 is applied to a member holding the base member 9. Therefore, in this case, printing of the density grid image of 0% is omitted (i.e., the basic displacement table is not generated) in generation of the distortion information and displacement vectors derived from other density grid images are stored. In generation of writing data, the displacement vectors are used similarly to the additional displacement vectors in the above explanation to obtain density displacement vectors of each color and resultant displacement vectors are acquired from a plurality of colors of density displacement vectors. Then, the target image is modified in conformity with a modified grid line group derived from the resultant displacement vectors, to thereby print the target image on the base member with accuracy.

Also, in generation of the distortion information, there may be a case where, with respect to each color, for example, the density grid image of 50% is only printed on the reference base member and only one additional displacement table is acquired (with respect to one color, the density grid image of 0% is printed and the basic displacement table is acquired). In this case, a density displacement vector of each color is obtained through linear interpolation to acquire a modified grid line group. However, when the transparent base member 9 is used as display panels of various apparatuses, ink can be applied on the base member 9 more thickly than usual, for achieving sufficient light shielding. In this case, if an additional displacement table of one density is only used, there is a limitation to achieve high precision of the image printed on the base member 9. Therefore, in a case where an object to be printed is the transparent base member 9, it is preferable a plurality of densities of additional displacement tables, a range between adjacent densities being determined according to the accuracy required in the image printed in the printer 1, are acquired for each color.

Though the basic displacement vector and the additional displacement vector represent a distortion amount (or an additional distortion amount) in the X direction and the Y direction relative to each standard intersection point in the distortion information in the above preferred embodiments, for example, each table may represent ratios between distortion amounts in the X and Y directions relative to distances in the X and Y directions between a predetermined standard point and each standard intersection point (the ratios corresponding to distortion rates of the base member 9 in looking at each standard intersection point).

In the printer 1, the plurality of distortion informations may be prepared in association with temperatures of the stage 21, kinds of ink ejected from the head 3, or the like.

In the operations of Steps S114 to S117 in FIG. 15, the evaluation density relative to each standard intersection point may be, for example, an evaluation value of a standard divided area 711 on the (−x) side and the (−y) side of the standard intersection point, an average value of evaluation values of standard divided areas 711 arranged in the y direction on the (−x) side of the standard intersection point, or the like. However, as discussed above, considering that in the printer 1 the head 3 performs sub scanning in the (+X) direction by a distance smaller than the width in the X direction of the head 3 and the head 3 passes each standard intersection point four times to complete the ejection control of ink to positions close to the standard intersection point, it is preferable an evaluation density of each standard intersection point is obtained from evaluation values of standard divided areas 711 around the standard intersection point.

In the preferred embodiments, the light irradiation part 38 moves relatively to the stage 21, in a state where the UV light are emitted, before the start time of the first printing (before the start time of printing which is first performed after the light irradiation part 38 is switched from the OFF state to the ON state) and the stage 21 is heated up to near the saturation temperature, to thereby print a high accurate image with high reproduction (i.e., the light irradiation part 38 is included in the temperature control part.). Depending on design of the printer 1, however, it is also possible to heat the stage 21 up to near the saturation temperature by the circulator 212.

In the reciprocal movement of the head 3 relatively to the base member 9 in the Y direction, the ejection control of ink in the head 3 may be performed in both the forward and backward paths in the printer 1. In this case, it is preferable the light irradiation parts 38 are provided in both the (+Y) direction and the (−Y) direction of the nozzle units 31 and ink which has just been ejected onto the base member 9 is hardened by the UV light emitted from the light irradiation parts 38 in each of the forward and backward paths of the head 3.

The light curable ink used in the printer 1 may have curability to lights included in a wavelength band other than that of ultraviolet. In this case, the light emitted from the light irradiation part 38 includes the wavelength band.

Although the head 3 moves relatively to the stage 21 in the main scan direction and the sub scan direction by the stage moving mechanism 22 for moving the stage 21 in the main scan direction and the head moving mechanism 24 for moving the head 3 in the sub scan direction in the above preferred embodiments, a mechanism for moving the head 3 in the main scan direction and a mechanism for moving the stage 21 in the sub scan direction may be provided in the printer 1. That is to say, a scanning mechanism for moving the head 3 having the nozzle units 31 and the light irradiation part 38 relatively to the stage 21 in the main scan direction and intermittently moving the head 3 relatively to the stage 21 in the sub scan direction every time movement in the main scan direction is performed, may have any construction.

The holding part for holding the base member 9 in the printer 1 may be one other than the stage 21, for example, may be one for holding only the outer part of the base member 9 as discussed above or the like.

Although the base member 9 need not be transparent, the printer 1 is especially suitable for printing of an image on the transparent base member 9 with translucency to the UV light emitted from the light irradiation part 38 because the average density or the density distribution of a printed image greatly affects distortion of such a base member 9 caused by the light emitted from the light irradiation part 38.

The printer 1 may be used in printing on other printing medium with hydrophobicity to ink (non-permeability of ink), such as a coated paper coated with predetermined material, on which a smoothing operation is performed, as well as plastic. The printer 1 using light curable ink is especially suitable for the uses of printing on a printing medium with hydrophobicity but can be used for a printing medium without hydrophobicity.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2006-352340 filed in the Japan Patent Office on Dec. 27, 2006, the entire disclosure of which is incorporated herein by reference.

What is claimed is:

1. An inkjet printer, comprising:
a holding part for holding a printing medium;
a head having a plurality of outlets arranged in a predetermined arrangement direction which is parallel to said printing medium, said plurality of outlets ejecting fine droplets of light curable ink onto said printing medium;
a light irradiation part for irradiating light to ink which is ejected onto said printing medium;
a scanning mechanism for moving said head and said light irradiation part relatively to said holding part in a main scan direction perpendicular to said arrangement direction and intermittently moving said head and said light irradiation part relatively to said holding part in a sub scan direction along said arrangement direction every time when movement in said main scan direction is performed;
a storage part for storing distortion information representing a relationship between an average density or a density distribution of an image printed on a printing medium and distortion of said printing medium by temperature rise caused by irradiation with said light;
an operation part for generating writing data by modifying a target image to be printed on the basis of said distortion information and an average density or a density distribution of said target image; and
a control part which controls relative movement of said head by said scanning mechanism and ejection of ink from said head in synchronization with each other, in accordance with said writing data.

2. The printer according to claim 1, wherein
said operation part obtains respective densities of a plurality of divided areas acquired by dividing said target image to acquire said density distribution of said target image and generates said writing data on the basis of said density distribution.

3. The printer according to claim 1, wherein
said target image is a set of a plurality of color component images which respectively correspond to a plurality of colors,
said head ejects fine droplets of inks of said plurality of colors onto said printing medium,
said distortion information represents, with respect to each of said plurality of colors, a relationship between an average density or a density distribution of an image printed on a printing medium and distortion of said printing medium by temperature rise caused by irradiation with said light, and
said operation part acquires said writing data by modifying said plurality of color component images in the same manner on the basis of said distortion information and a plurality of average densities or a plurality of density distributions of said plurality of color component images.

4. The printer according to claim 2, wherein
said target image is a set of a plurality of color component images which respectively correspond to a plurality of colors,
said head ejects fine droplets of inks of said plurality of colors onto said printing medium,
said distortion information represents, with respect to each of said plurality of colors, a relationship between a density distribution of an image printed on a printing medium and distortion of said printing medium by temperature rise caused by irradiation with said light, and
said operation part acquires said writing data by modifying said plurality of color component images in the same manner on the basis of said distortion information and a plurality of density distributions of said plurality of color component images.

5. The printer according to claim 1, wherein
said holding part is a stage which is in contact with a surface of said printing medium, and
said printing medium held on said stage has translucency to said light.

6. The printer according to claim 5, further comprising
a temperature control part for controlling a temperature of said stage to make said temperature at the start time of the first printing constant.

7. The printer according to claim 6, wherein
said temperature control part includes said light irradiation part which moves relatively to said stage, in a state where said light is emitted, before said start time of said first printing.

8. The printer according to claim 1, wherein
said writing data includes:
image data acquired by distorting said target image in a direction corresponding to said sub scan direction; and
modification data for shifting ejection timing of ink in main scanning of said head.

9. The printer according to claim 1, wherein
said writing data contains image data acquired by distorting said target image in a direction corresponding to said sub scan direction and a direction corresponding to said main scan direction.

10. The printer according to claim 1, wherein
said distortion information is associated with the number of times where said head passes each position on said printing medium in printing.

11. A printing method of printing in an inkjet printer which comprises a holding part for holding a printing medium, a head having a plurality of outlets arranged in a predetermined arrangement direction which is parallel to said printing medium, said plurality of outlets ejecting fine droplets of light curable ink onto said printing medium, a light irradiation part for irradiating light to ink which is ejected onto said printing medium, and a scanning mechanism for moving said head and said light irradiation part relatively to said holding part in a main scan direction perpendicular to said arrangement direction and intermittently moving said head and said light irradiation part relatively to said holding part in a sub scan direction along said arrangement direction every time when movement in said main scan direction is performed, comprising the steps of:
a) preparing distortion information representing a relationship between an average density or a density distribution of an image printed on a printing medium and distortion of said printing medium by temperature rise caused by irradiation with said light;
b) generating writing data by modifying a target image to be printed on the basis of said distortion information and an average density or a density distribution of said target image; and
c) controlling relative movement of said head by said scanning mechanism and ejection of ink from said head in synchronization with each other, in accordance with said writing data.

12. The printing method according to claim 11, wherein
respective densities of a plurality of divided areas acquired by dividing said target image are obtained to acquire said density distribution of said target image and said writing data is generated on the basis of said density distribution in said step b).

13. The printing method according to claim 11, wherein
said target image is a set of a plurality of color component images which respectively correspond to a plurality of colors,
said head ejects fine droplets of inks of said plurality of colors onto said printing medium,
said distortion information represents, with respect to each of said plurality of colors, a relationship between an average density or a density distribution of an image printed on a printing medium and distortion of said printing medium by temperature rise caused by irradiation with said light, and
said writing data is acquired by modifying said plurality of color component images in the same manner on the basis of said distortion information and a plurality of average densities or a plurality of density distributions of said plurality of color component images in said step b).

14. The printing method according to claim 12, wherein
said target image is a set of a plurality of color component images which respectively correspond to a plurality of colors,
said head ejects fine droplets of inks of said plurality of colors onto said printing medium,
said distortion information represents, with respect to each of said plurality of colors, a relationship between a density distribution of an image printed on a printing medium and distortion of said printing medium by temperature rise caused by irradiation with said light, and
said writing data is acquired by modifying said plurality of color component images in the same manner on the basis of said distortion information and a plurality of density distributions of said plurality of color component images in said step b).

15. The printing method according to claim 11, wherein
said holding part is a stage which is in contact with a surface of said printing medium, and
said printing medium held on said stage has translucency to said light.

16. The printing method according to claim 15, further comprising
d) controlling a temperature of said stage to make said temperature at the start time of the first printing constant.

17. The printing method according to claim 16, wherein
said light irradiation part moves relatively to said stage, in a state where said light is emitted, before said start time of said first printing in said step d).

18. The printing method according to claim 11, wherein
said writing data includes:
image data acquired by distorting said target image in a direction corresponding to said sub scan direction; and
modification data for shifting ejection timing of ink in main scanning of said head.

19. The printing method according to claim 11, wherein
said writing data contains image data acquired by distorting said target image in a direction corresponding to said sub scan direction and a direction corresponding to said main scan direction.

20. The printing method according to claim 11, wherein
said distortion information is associated with the number of times where said head passes each position on said printing medium in printing.
